(19) United States
(12) Patent Application Publication
(10) Pub. No.: US 2009/0025293 A1
(43) Pub. Date: Jan. 29, 2009

(54) APPARATUS, SYSTEM, AND METHOD FOR PROCESSING HYDROGEN GAS

(76) Inventors: John Patton, West Jordan, UT (US); Ken Pearson, Shingle Springs, CA (US); Chris Brydon, Salt Lake City, UT (US)

Correspondence Address: Kunzler & McKenzie, 8 EAST BROADWAY, SUITE 600, SALT LAKE CITY, UT, 84111, US

(21) Appl. No.: 12/179,578

(22) Filed: Jul. 24, 2008

Related U.S. Application Data
(60) Provisional application No. 60/951,907, filed on Jul. 25, 2007.
(60) Provisional application No. 60/951,903, filed on Jul. 25, 2007.
(60) Provisional application No. 60/951,925, filed on Jul. 25, 2007.
(60) Provisional application No. 61/059,743, filed on Jun. 6, 2008.

(51) Int. Cl. B01J 7/00

(52) U.S. Cl. 48/199 FM; 48/61

(57) ABSTRACT

An apparatus, system, and method are disclosed for processing a hydrogen gas stream comprising a housing, a condensing media, a mechanical filtration element, a coalescer element, and an outlet port. The housing comprises a heat- and pressure-resistant material and has an internal chamber configured to receive a hydrogen gas stream. A condenser may cool the hydrogen gas stream to promote water condensation. The condensing media removes entrained liquid water from the hydrogen gas stream. The mechanical filtration element receives the hydrogen gas stream as the hydrogen gas stream exits the condensing media. The mechanical filtration element collects particulate matter from the hydrogen gas stream. The coalescer element receives the hydrogen gas stream as the hydrogen gas stream exits the mechanical filtration element. The coalescer element removes substantially all of the liquid water formed in the hydrogen gas stream. The outlet port delivers the hydrogen gas stream outside the housing.

### CROSS-REFERENCES TO RELATED APPLICATIONS

This application claims the benefit of U.S. Provisional Patent Application No. 60/951,907 entitled “APPARATUS, SYSTEM, AND METHOD FOR CLEANING HYDROGEN GAS GENERATED FROM A CHEMICAL HYDRIDE” and filed on Jul. 25, 2007 for John Patton, et. al which is incorporated herein by reference. The application incorporates by reference U.S. Provisional Application Ser. Nos. 60/627,257 filed Nov. 12, 2004, 60/632,460 filed Dec. 2, 2004, 60/655,373 filed Feb. 23, 2005, 60/683,024 filed May 20, 2005, 60/688,456 filed Jun. 8, 2005, 60/820,574 filed Jul. 27, 2006, 60/951,903 filed Jul. 25, 2007, 60/951,925 filed Jul. 25, 2007, and 61/059,743 filed Jun. 6, 2008 and U.S. patent application Ser. Nos. 10/459,991 filed Jun. 11, 2003, 11/270,947 filed Nov. 12, 2005, 11/740,349 filed Apr. 26, 2007, 11/828,265 filed Jul. 25, 2007, 11/829,019 filed Jul. 26, 2007, and 11/829,035 filed Jul. 26, 2007, each of which is incorporated by reference herein in its entirety.

### BACKGROUND OF THE INVENTION

1. Field of the Invention

This invention relates to generating electricity and more particularly relates to generating electricity from a chemical hydride.

2. Description of the Related Art

As the cost of fossil fuels increases, pollution increases, and the worldwide supply of fossil fuels decreases, alternative energy sources are becoming increasingly important. Hydrogen is a plentiful alternative energy source, but it generally exists in a combination with other elements, and not in a pure form. The additional elements add mass and may prevent the hydrogen from being used as an energy source. Pure hydrogen, however, is a desirable energy source. Pure hydrogen comprises free hydrogen atoms, or molecules comprising only hydrogen atoms. Producing pure hydrogen using conventional methods is generally cost prohibitive.

One way that pure hydrogen can be generated is by a chemical reaction which produces hydrogen molecules. The chemical reaction that occurs between water (H₂O) and chemical hydrides produces pure hydrogen. Chemical hydrides are molecules comprising hydrogen and one or more alkali or alkali-earth metals. Examples of chemical hydrides include lithium hydride (LiH), lithium tetrahydridoaluminate (LiAlH₄), lithium tetrahydridoborate (LiBH₄), sodium hydride (NaH), sodium tetrahydridoaluminate (NaAlH₄), sodium tetrahydridoborate (NaBH₄), and the like. Chemical hydrides produce large quantities of pure hydrogen when reacted with water, as shown in reaction 1.

NaBH₄+2H₂O→NaBO₂+4H₂ (1)

Recently, the interest in hydrogen generation has increased, because of the development of lightweight, compact Proton Exchange Membrane (PEM) fuel cells. One by-product of generating electricity with a PEM fuel cell is water, which can be used or reused to produce pure hydrogen from chemical hydrides for fuelling the PEM fuel cell. The combination of PEM fuel cells with a chemical hydride hydrogen generator offers advantages over other energy storage devices in terms of gravimetric and volumetric energy density.

Unfortunately, the prior art has encountered unresolved problems producing pure hydrogen from chemical water/hydride reactions. The chemical reaction between water and a chemical hydride produces a hydrogen gas stream that contains impurities, such as salts, acids, organic compounds, and the like. The hydrogen stream is processed to remove excess heat, moisture, and contaminants before the hydrogen gas stream is introduced into a fuel cell. The problem facing the industry is how to purify the hydrogen gas stream in view space and weight constraints, particularly for portable hydrogen generation applications. The usual methods of filtering require so much extra space and weight that they can negate the benefit of high gravimetric and volumetric energy density provided by the chemical hydrides.

Accordingly, what is needed is an improved apparatus, system, and method that overcome the problems and disadvantages of the prior art. The apparatus, system, and method should substantially process a hydrogen gas stream to provide a suitable hydrogen gas stream in a fuel cell. In particular, the apparatus, system, and method should remove specific contaminants present in a hydrogen gas stream produced by hydrolysis.

### SUMMARY OF THE INVENTION

From the foregoing discussion, it should be apparent that a need exists for an apparatus, system, and method that processes a hydrogen gas stream. Beneficially, such an apparatus, system, and method would cool the hydrogen gas stream, condense and collect water vapor, and filter contaminants.

The present invention has been developed in response to the present state of the art, and in particular, in response to the problems and needs in the art that have not yet been fully solved by currently available filtration technologies. Accordingly, the present invention has been developed to provide an apparatus, system, and method for processing hydrogen gas that overcome many or all of the above-discussed shortcomings in the art.

The present invention includes an apparatus for processing a hydrogen gas stream generated from a chemical hydride comprising a housing, a condensing media, a coalescer element, and an outlet port. The housing comprises a heat- and pressure-resistant material and has an internal chamber configured to receive a hydrogen gas stream. The condensing media is disposed within the internal chamber. The condensing media has a plurality of condensing passages sized to engage liquid water entrained in the hydrogen gas stream to remove the entrained liquid water from the hydrogen gas stream. The liquid water forms as the hydrogen gas stream cools.

The coalescer element is disposed within the internal chamber to receive the hydrogen gas stream as the hydrogen gas stream exits the condensing media. The coalescer element removes liquid water formed in the hydrogen gas stream as the hydrogen gas stream cools. The outlet port is disposed in the housing in fluid communication with the internal chamber. The outlet port is configured to receive the hydrogen gas stream as the hydrogen gas stream exits the coalescer element and to deliver the hydrogen gas stream outside the housing.

In certain embodiments, the apparatus further comprises a condenser. The condenser may comprise a channel defined by at least one wall, which absorbs heat from the hydrogen gas stream. The channel, in one embodiment, delivers the hydrogen gas stream to the internal chamber upstream of the condensing media.

The condenser may comprise a corrosion-resistant material with a thermal conductivity greater than about 5 W/m·K. The condenser may further comprise a cooling module that conducts heat from the condenser to a surrounding environment. The cooling module may comprise a fluid circulation device that circulates a cooling fluid (either liquid or gas) in contact with the material forming the at least one wall. In one embodiment, the apparatus further comprises a mechanical filtration element. The mechanical filtration element may be disposed within the internal chamber to receive the hydrogen gas stream as the hydrogen gas stream exits the condensing media and deliver the hydrogen gas stream to the coalescer element. The mechanical filtration element may have a plurality of filtration passages sized to collect particulate matter larger than a selected diameter from the hydrogen gas stream.

In some embodiments, the apparatus comprises a pre-filter that receives the hydrogen gas stream before the hydrogen gas stream enters the condensing media. The pre-filter may have a plurality of filtration passages comprising a material that collects contaminants from the hydrogen gas stream.

In certain embodiments, one or more of the condensing media, the mechanical filtration element, the pre-filter, and the coalescer element are located within a chemical hydride fuel cartridge. The apparatus may comprise a pre-filter that receives the hydrogen gas stream before the hydrogen gas stream enters the condensing media. The pre-filter may have a plurality of filtration passages comprising a material that collects one or more of solid contaminants and gaseous contaminants from the hydrogen gas stream. The pre-filter may comprise one or more materials. Each material may be chosen for its ability to remove one or more specific contaminants from the hydrogen gas stream. The apparatus may be configured such that the hydrogen gas stream exiting the outlet port has a temperature within an operating temperature threshold of a fuel cell configured to consume the hydrogen gas stream and a relative humidity less than or equal to 100 percent.

The apparatus may comprise an organic filter that receives the hydrogen gas stream from the coalescer element and captures one or more of organic vapor contamination and inorganic vapor contamination from the hydrogen gas stream. The apparatus may further comprise a hydrogen-selective membrane that receives the hydrogen gas stream upstream from the outlet port.

In one embodiment, the invention is an apparatus for processing a hydrogen gas stream generated from a chemical hydride comprising a housing, an inlet port, a condenser, a condensing media, a mechanical filtration element, a coalescer element, and an outlet port. The housing may comprise a heat- and pressure-resistant material. The housing may have a condensing chamber and a coalescing chamber. The housing may be configured to receive a hydrogen gas stream.

The inlet port may be disposed in the housing in fluid communication with a condenser. The inlet port may be configured to deliver the hydrogen gas stream to the condenser. The condenser may comprise a channel defined by at least one wall which absorbs heat from the hydrogen gas stream. The channel delivers the hydrogen gas stream to a bypass tube disposed between the condenser and the condensing chamber.

The condensing media is disposed within the condensing chamber. The condensing media may have a plurality of condensing passages sized to engage liquid water entrained in the hydrogen gas stream to remove the entrained liquid water from the hydrogen gas stream. The liquid water forms as the hydrogen gas stream cools. The mechanical filtration element may be disposed between the condensing chamber and the coalescing chamber. The mechanical filtration element may receive the hydrogen gas stream as the hydrogen gas stream exits the condensing media. The mechanical filtration element may have a plurality of filtration passages sized to collect particulate matter larger than a selected diameter from the hydrogen gas stream.

The coalescer element may be disposed within the coalescing chamber to receive the hydrogen gas stream as the hydrogen gas stream exits the mechanical filtration element. The coalescer element may remove substantially all of the liquid water formed in the hydrogen gas stream as the hydrogen gas stream cools. The outlet port may be disposed in the housing in fluid communication with the coalescing chamber. The outlet port may be configured to receive the hydrogen gas stream as the hydrogen gas stream exits the coalescer element and deliver the hydrogen gas stream outside the housing.

The apparatus may be configured such that the hydrogen gas stream exiting the outlet port has a temperature within an operating temperature threshold of a fuel cell configured to consume the hydrogen gas stream, and a relative humidity less than or equal to 100%. The condenser may further comprise a cooling module that conducts heat from the condenser to a surrounding environment. The cooling module may comprise a fluid circulation device that circulates a fluid in contact with the at least one wall.

In one embodiment, the invention is a method for processing a hydrogen gas stream generated from a chemical hydride comprising cooling the hydrogen gas stream, engaging liquid water, collecting particulate matter, removing substantially all of the liquid water, and delivering the hydrogen gas stream. The method begins with cooling a hydrogen gas stream generated from a chemical hydride in a condenser. The condenser may comprise a channel defined by at least one wall which absorbs heat from the hydrogen gas stream. The channel may deliver the hydrogen gas stream to a single housing. The housing may have an internal chamber configured to receive the hydrogen gas stream.

The method continues with engaging liquid water in the hydrogen gas stream within a plurality of condensing passages of a condensing media. The condensing media may be disposed within the internal chamber of the housing. The liquid water forms as the hydrogen gas stream cools. Particulate matter larger than a selected diameter is collected from the hydrogen gas stream in a plurality of filtration passages of a mechanical filtration element. The mechanical filtration element may be disposed within the internal chamber to receive the hydrogen gas stream as the hydrogen gas stream exits the condensing media. In a coalescer element, substantially all of the liquid water is removed from the hydrogen gas stream. The coalescer element may be disposed within the internal chamber to receive the hydrogen gas stream as the hydrogen gas stream exits the mechanical filtration element. The liquid water forms in the hydrogen gas stream as the hydrogen gas stream cools. The final step may be delivering the hydrogen gas stream from the housing. The hydrogen gas stream may have a temperature within an operating temperature threshold of a fuel cell configured to consume the hydrogen gas stream and a relative humidity less than or equal to 100 percent.

In some embodiments, the method of the invention further comprises pre-filtering the hydrogen gas stream in a pre-filter before the hydrogen gas stream enters the condenser. The pre-filter may have a plurality of filtration passages comprising a material that collects solid and/or gaseous contaminants from the hydrogen gas stream. In certain embodiments, the apparatus is configured such that the hydrogen gas stream exiting the housing has less than 0.5 percent contaminants. The method may also comprise collecting water recovered from the hydrogen gas stream and delivering the collected water to a chemical hydride water supply reservoir.

In one embodiment, the current invention is a system to generate electric power from a chemical hydride, the system comprising a removable fuel cartridge, a condenser, a coalescer, a fuel cell stack, an electric power storage device, one or more water pumps, and a controller. The removable fuel cartridge may be configured to produce a hydrogen gas stream by reacting water with a chemical hydride. The condenser may receive the hydrogen gas stream. The condenser may have a plurality of condensing passages sized to engage liquid water entrained in the hydrogen gas stream to remove the entrained liquid water from the hydrogen gas stream. The liquid water forms as the hydrogen gas stream cools. The coalescer may receive the hydrogen gas stream from the condenser. The coalescer may have a coalescer element that receives the hydrogen gas stream as the hydrogen gas stream exits the condenser. The coalescer element may remove substantially all of the liquid water formed in the hydrogen gas stream as the hydrogen gas stream cools.

A fuel cell stack may be configured to receive the hydrogen gas stream and to generate electric power using air and the hydrogen gas stream. An electric power storage device may be coupled with the fuel cell stack. The electric power storage device may be configured to store and supply electric power. One or more water pumps may be configured to inject water from a water supply into the fuel cartridge at a variable rate. A controller may be configured to manage a water injection rate for each of the one or more water pumps based on power demands of an electric load coupled to the system. In certain embodiments, the fuel cartridge is replaceable and comprises a pre-filter configured to collect solid and fluid contaminants from the produced hydrogen. The condenser may comprise a channel defined by at least one wall. The wall may absorb heat from the hydrogen gas stream prior to the hydrogen gas stream contacting the condensing media.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for generating electricity from a chemical hydride in accordance with the present invention;

FIG. 2 is a schematic block diagram illustrating one embodiment of a hydrogen fuel cartridge in accordance with the present invention;

FIG. 3A is a schematic block diagram illustrating a further embodiment of a hydrogen fuel cartridge in accordance with the present invention;

FIG. 3B is a schematic block diagram illustrating one embodiment of a water permeable material in accordance with the present invention;

FIG. 4A is a schematic block diagram illustrating one embodiment of a hydrogen cleaning system in accordance with the present invention;

FIG. 4B is a schematic block diagram illustrating one embodiment of a hydrogen cleaning system in accordance with the present invention;

FIG. 5 is a schematic block diagram illustrating one embodiment of a pre-filter in accordance with the present invention;

FIG. 6 is a schematic block diagram illustrating one embodiment of a condenser in accordance with the present invention;

FIG. 7 is a schematic block diagram illustrating one embodiment of a coalescer in accordance with the present invention;

FIG. 8 is a schematic block diagram illustrating one embodiment of a hydrogen generation and cleaning system in accordance with the present invention;

FIG. 9 is a schematic flow chart illustrating one embodiment of a method for cleaning hydrogen gas generated by a chemical hydride according to the present invention;

FIG. 10 is a schematic diagram illustrating one embodiment of an apparatus for processing a hydrogen gas stream according to the present invention; and

FIG. 11 is a schematic diagram illustrating one embodiment of a condenser comprising a channel in accordance with the present invention.

### DETAILED DESCRIPTION OF THE INVENTION

Many of the functional units described in this specification have been labeled as modules, in order to more particularly emphasize their implementation independence. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of mechanical design, electrical connections, hardware circuits, manufacturing techniques, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

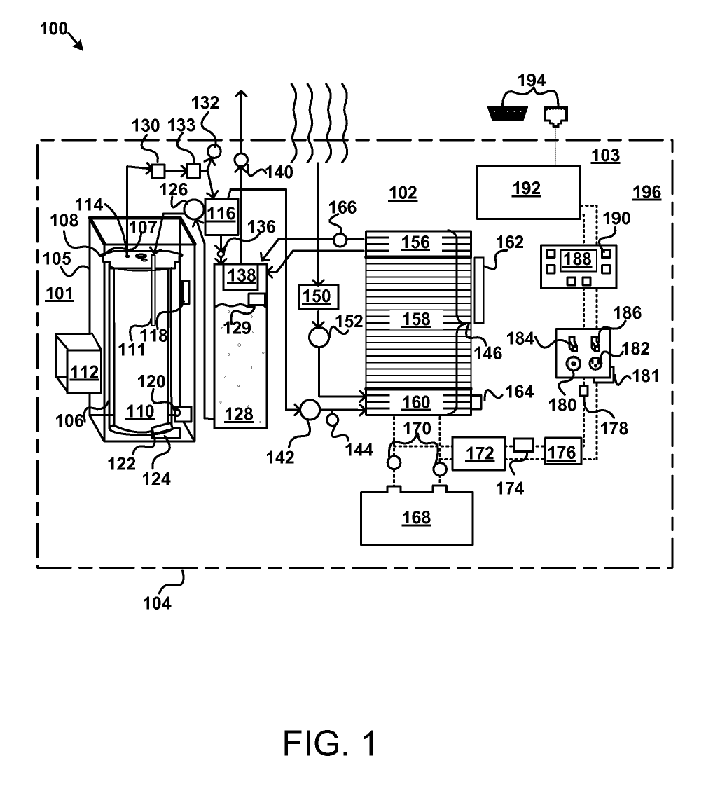

FIG. 1 depicts one embodiment of a system 100 for generating electricity from a chemical hydride in accordance with the present invention. The system 100 includes a hydrogen generation system 101, a hybrid hydrogen fuel cell system 102, an electrical and control system 103, and an outer housing 104.

In one embodiment, the hydrogen generation system 101 includes one or more cartridge housings 105, one or more hydrogen fuel cartridges 106, one or more alignment structures 108, a water permeable material 110, one or more water injection lines and tubes 111, one or more cooling modules 112, one or more hydrogen ports 114, a hydrogen processing system 116, a temperature sensor 118, a cartridge sensor 120, a radio frequency identification (RFID) tag 122, an RFID sensor 124, a water pump 126, a water reservoir 128, a water level sensor 129, a check valve 130, a hydrogen pressure sensor 132, one or more mechanical valves 133, a transfer valve 136, a water condenser 138, and an air pressure control valve 140. In general, the hydrogen generation system 101 generates hydrogen using water, a chemical hydride, and an activating agent.

In one embodiment, the cartridge housing 105 comprises a durable material that can withstand high temperatures associated with hydrogen generation. In a further embodiment, the cartridge housing 105 also comprises a lightweight material, to keep the overall weight of the system 100 to a minimum for added portability. In one embodiment, the cartridge housing 105 is a lightweight metal or metal alloy such as aluminum or the like. In a further embodiment, the cartridge housing 105 comprises a fiberglass material, a plastic polymer material, a ceramic material, or another durable material. In one embodiment, the cartridge housing 105 also comprises structures configured to receive, align, and lock the hydrogen fuel cartridge 106.

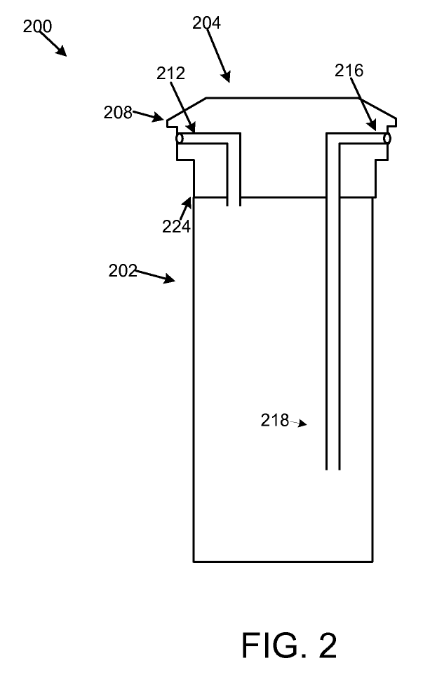

In one embodiment, the hydrogen fuel cartridge 106 locks into the cartridge housing 105. The hydrogen fuel cartridge 106 is discussed in greater detail with reference to FIG. 2. In general, the hydrogen fuel cartridge 106 is configured to house a chemical hydride and an activating agent, to receive water, to house a chemical reaction between the chemical hydride and the water which produces hydrogen gas, and to release the hydrogen. In one embodiment, the hydrogen fuel cartridge 106 is cylindrical in shape. The cylindrical shape provides structural strength to withstand the internal pressures as hydrogen is produced. The hydrogen fuel cartridge 106 may comprise a material configured to withstand the heat and pressure of the chemical reaction. The material may also comprise a lightweight material selected to minimize the weight of the hydrogen fuel cartridge 106, such as a lightweight metal or metal alloy like aluminum, a plastic polymer, or other durable material. In another embodiment, the hydrogen fuel cartridge 106 comprises a stamped aluminum cylindrical cartridge.

In one embodiment, the hydrogen generation system 101 includes alignment structures 107, a shoulder, guide blocks, guide pins, or the like which may mate with corresponding alignment structures 108 on the hydrogen fuel cartridge 106. In another embodiment, the cartridge housing 105 may include alignment structures 107, guide blocks, guide pins, or the like which may mate with corresponding alignment structures 108 on the hydrogen fuel cartridge 106.

In one embodiment, the top of the hydrogen fuel cartridge 106 has one or more alignment structures 108. In one embodiment, the one or more alignment structures 108 are configured to engage one or more corresponding alignment structures 107 of the cartridge housing 105. The alignment structures 107 of the cartridge housing 105 may be a shoulder, guide blocks, pins, bolts, screws, keys, or the like. Advantageously, the alignment structures 108 provide for quick and safe installation of a fresh hydrogen fuel cartridge 106. In one embodiment, the hydrogen fuel cartridge 106 is oriented vertically with respect to the outer housing 104. In this manner, a user may quickly remove a used hydrogen fuel cartridge 106 and insert a fresh hydrogen fuel cartridge 106. In a further embodiment, the hydrogen fuel cartridge 106 is oriented horizontally with respect to the outer housing 104. The alignment structures 108 ensure that inlet ports of the hydrogen fuel cartridge 106 line up and seal properly.

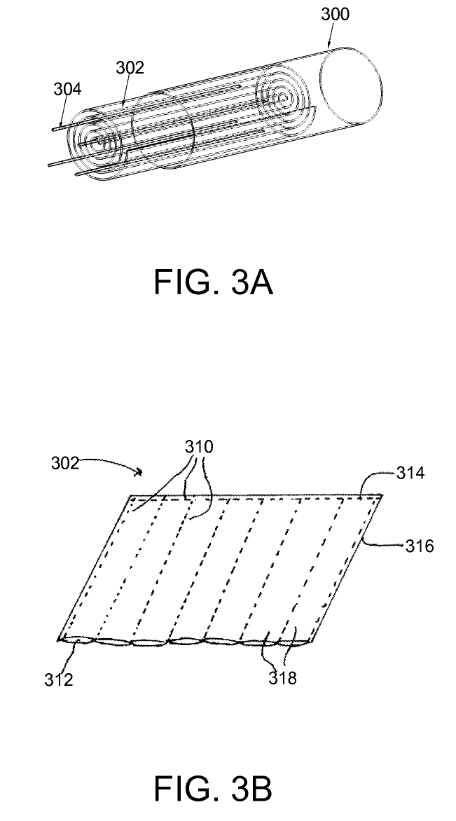

In one embodiment, the chemical hydride and the activating agent are stored in a water permeable material 110 within the hydrogen fuel cartridge 106. The water permeable material 110 is discussed in greater detail with reference to FIGS. 3A and 3B. In general, the water permeable material 110 comprises a material configured to distribute water evenly, without retaining a significant amount of water. In a further embodiment, the water permeable material 110 is further configured with one or more sections or pouches, each section or pouch configured to hold and to evenly distribute a predetermined amount of the chemical hydride and the activating agent. The water permeable material 110 may be rolled as illustrated in FIG. 1, or may be in multiple rolls, folds, stacks, or other configurations. In one embodiment, the hydrogen fuel cartridge 106 includes a plurality of water permeable materials 110, each rolled as illustrated in FIG. 1, and distributed about a central longitudinal axis of the hydrogen fuel cartridge 106, with a central rolled water-permeable material 110 centered about the central longitudinal axis of the hydrogen fuel cartridge 106.

In one embodiment, water enters the hydrogen fuel cartridge 106 through one or more water injection tubes 111. In one embodiment, the water injection tubes 111 may be coupled to the cartridge housing 105 with an O-ring or similar seal, and the cartridge housing 105 may be coupled to the water pump 126 by one or more water lines. The water injection tubes 111 are configured to disperse water within the water permeable material 110, such that the water and the chemical hydride react to release hydrogen gas. The chemical hydride may be an inorganic compound or an organic compound. In one embodiment, the cartridge 106 is oriented vertically, and the water injection tubes 111 are configured to fill the cartridge 106 with water from the bottom of the cartridge 106. In a further embodiment, the cartridge 106 is oriented horizontally, and the water injection tubes 111 are configured to evenly disperse water in the horizontal cartridge 106. In one embodiment, the hydrogen fuel cartridge 106 may comprise a plurality of water injection tubes 111. In another embodiment, the hydrogen fuel cartridge 106 includes one or more switching valves allowing water to be selectively injected through one or more water injection tubes and not other water injection tubes.

In one embodiment, the cooling module 112 is coupled to the cartridge housing 105. The cooling module 112 is configured to disperse the heat produced by the chemical reaction between the water and the chemical hydride. In one embodiment, the cooling module 112 includes a fluid circulation device. This fluid circulation device may be a low power fan that provides high airflow. The cooling module 112 may circulate different types of fluids, and the fluids may be liquid or gaseous. One skilled in the art will recognize that the fluid can be air, water, a mixture of water and glycol, or the like. In a further embodiment, the electrical and control system 103 may adjust the airflow from the cooling module 112 according to the temperature of the fuel cartridge 106 as measured by the temperature sensor 118 to reduce parasitic power losses.

In another embodiment, the cooling module 112 comprises one or more blowers that are not affected by backpressure within the cartridge housing 105. The cooling module 112 is configured to maintain a higher air pressure than an axial fan. One or more forms, guides, manifolds, or heat dams may be used to control and direct the flow of air around the fuel cartridge 106. In a further embodiment, the cooling module 112 may comprise a water pump configured to pump water around the cartridge 106 to facilitate a heat transfer between the cartridge and the water. The water pump may pump the water through tubing, pipes, or through channels in the housing 105 or the cartridge 106. A heat sink comprising a metal, graphite, or other thermally conductive material may also be used.

In one embodiment, one or more hydrogen ports 114 are integrated with the alignment structures 108 on the hydrogen fuel cartridge 106. In a further embodiment, the hydrogen ports 114 are in fluid communication with one or more port connectors in the cartridge housing 105. The hydrogen port connectors in the cartridge housing 105 may include seals or O-rings.

In one embodiment, hydrogen gas exiting the inside of the hydrogen fuel cartridge 106 passes through a hydrogen processing system 116. In one embodiment, the hydrogen processing system 116 is integrated with the hydrogen fuel cartridge 106. In this manner, the hydrogen processing system 116 is replaced when the hydrogen fuel cartridge 106 is replaced. The hydrogen processing system 116, in one embodiment, is located near the top of the hydrogen fuel cartridge 106 between the hydrogen ports 114 and the water permeable material 108. In another embodiment, the hydrogen processing system 116 is located external to, and downstream of, the hydrogen fuel cartridge 106. The hydrogen processing system 116 is configured to remove impurities such as hydrocarbons or other organic compounds, water vapor, dissolved or solid salts, or other impurities from the generated hydrogen gas. The hydrogen processing system 116 may comprise one or more individual filters, condensers, or coalescers comprising material suitable for filtering impurities from hydrogen gas. The hydrogen processing system 116 may also comprise a particulate filter configured to remove particles greater than a predefined size from the hydrogen gas. In one embodiment, the predefined size is about 5 microns.

The hydrogen processing system 116 is configured to remove contaminants, condense water, and cool a hydrogen gas stream. The specific filtration elements selected for the hydrogen processing system 116 depend on the contaminants known or expected in the hydrogen gas stream. One skilled in the art will recognize that different filter types are known to filter certain contaminants. A combination of two or more filter types may allow for more efficient filtration of certain combinations of contaminants.

In one embodiment, the temperature sensor 118 is configured to monitor the temperature of the hydrogen fuel cartridge 106 and the cartridge housing 105. The temperature sensor 118 may make contact with, be disposed within, or otherwise read the temperature of the cartridge housing 105 and/or the cartridge 106. The temperature that the temperature sensor 118 reads may cause the electrical and control system 103 to activate or deactivate the cooling module 112 or adjust other system variables to meet predetermined safety and usability standards.

In one embodiment, one or more cartridge sensors 120 determine the presence or absence of the hydrogen fuel cartridge 106. In a further embodiment, the cartridge sensors 120 may also determine whether the hydrogen fuel cartridge 106 is properly aligned for operation. The cartridge sensors 120 may be one or more manual switches, optical sensors, magnetic sensors, or other types of sensors capable of determining when the fuel cartridge 106 is present. Preferably, the cartridge sensors 120 are optical sensors. Optical cartridge sensors 120 are easier to position and calibrate during the manufacturing process and provide precise measurements without wearing over time as may occur with mechanical switches. The cartridge sensors 120 may comprise multiple cartridge sensors in various positions in or around the hydrogen fuel cartridge 106, and the cartridge housing 105.

In one embodiment, the system 100 is configured to prevent hydrogen production unless one or more system sensors determine that the system 100 is in a proper system state. The one or more system sensors may be selected from the group consisting of the temperature sensors 118, 164, the cartridge sensor 120, the hydrogen pressures sensors 132, 144, and other system state sensors. In one embodiment, the system 100 prevents hydrogen production until the cartridge 106 is detected as present. In one embodiment, the electrical and control system 103 controls the hydrogen production based on inputs from one or more system sensors.

In one embodiment, the hydrogen fuel cartridge 106 includes an RFID tag 122 or other identifying device. The RFID tag 122 or other identifying device may be embedded in, mounted on, or otherwise coupled to the hydrogen fuel cartridge 106 such that it is readable by the RFID sensor 124 coupled to the cartridge housing 105. In a further embodiment, the RFID tag 122 includes a unique cartridge identification number. By uniquely identifying each cartridge 106, the system 100 may provide usage statistics to the user, including alerts when the cartridge 106 is low on fuel and when the cartridge 106 must be replaced, even when the cartridge 106 is removed from the system 100 prior to exhaustion and later returned to the system 100.

In one embodiment, the system 100 stores usage information for one or more hydrogen fuel cartridges 106 corresponding to the unique cartridge identification number associated with each hydrogen fuel cartridge 106. For example, the electrical and control system 103 may store the usage information. Usage information, including the amount of fuel remaining in the cartridge 106, may be collected by monitoring the amount of water injected into the cartridge 106, or by monitoring the amount of hydrogen that has exited the cartridge 106. Because the amount of reactants within the cartridge 106 is known, and the amount of reactant used with each pulse of water injected is known, a simple chemical reaction calculation can be used to determine how much hydride reactant has been used, and how much hydride reactant remains. In one embodiment, the electrical and control system 103 adjusts one or more system control parameters based on the usage information corresponding to a particular fuel cartridge 106.

In one embodiment, water is pumped into the hydrogen fuel cartridge 106 through the one or more water injection tubes 111 by the water pump 126. In one embodiment, the water pump 126 is configured to pump water in discrete pulses, according to a dynamic pulse rate determined by the hydrogen production or pressure demand and the power load. Pumping water at variable pulse rates provides very fine control over the amount of water supplied. In one embodiment, the pulse rate is determined using one or more mathematical or statistical curves. In a further embodiment, the pulse rate is determined using a hydrogen pressure curve and an electrical power demand curve, each curve having individual slopes and magnitudes. In one embodiment, the magnitudes at varying points along the curves signify an amount of time between pulses. The magnitudes may be positive or negative, with positive values signifying a slower pulse rate, and negative values signifying a faster pulse rate. When multiple curves are used, the magnitudes from each curve at the point on the curve corresponding to the system state may be added together to determine the pulse rate.

The water pump 126 is a pump capable of pumping water into the fuel cartridge 106 through the one or more water injection tubes 111. In one embodiment, the water pump 126 is a peristaltic pump. Use of a peristaltic pump is advantageous because a peristaltic pump cannot contaminate the liquid that it pumps, is inexpensive to manufacture, and pumps a consistent, discrete amount of liquid in each pulse. Advantageously, a peristaltic pump provides a consistent and discrete amount of liquid regardless of the backpressure in the water in the water injection tube 111.

In one embodiment, the amount of hydrogen gas produced, and the potential amount of hydrogen production remaining in the fuel cartridge 106 may be determined by tracking the number of pulses made by the pump 126. The electrical and control system 103 may determine the remaining hydrogen potential of the fuel cartridge 106 based on the amount of chemical hydride in the cartridge 106, the size of each pulse that the water pump 126 pumps, and the number of pulses that the water pump 126 has pumped. The water pump 126 pulse quantity may be defined based on the hydrogen gas requirements of the fuel cell 146. In one embodiment, the water pump 126 pulse quantity is between about 75 μL to 100 μL. In addition, a peristaltic pump 126 allows the control system 103 to reverse the direction of the pump to withdraw water from the cartridge 106 and thereby slow the production of hydrogen. This fine degree of control allows the production of hydrogen to more closely match the demands of the fuel cell 102.

The water pump 126 pumps water that is stored in the water reservoir 128. In another embodiment, a user may add water to the water reservoir 128 manually.

In one embodiment, the water level sensor 129 monitors the water level of the water reservoir 128. The water level sensor 129 may be an ultrasonic sensor, a float sensor, a magnetic sensor, pneumatic sensor, a conductive sensor, a capacitance sensor, a point level sensor, a laser sensor, an optical sensor, or another water level sensor. In a further embodiment, the water level sensor 129 comprises a window into the water reservoir 128 that allows a user to visually monitor the water level.

In one embodiment, the generated hydrogen passes through the check valve 130. The check valve 130 allows hydrogen to exit the cartridge 106, but prevents hydrogen from returning into the cartridge 106. The check valve 130 also prevents hydrogen from exiting the system 100 when the cartridge 106 has been removed. This conserves hydrogen, provides a safety check for the user, and allows an amount of hydrogen to be stored in the system 100 for later use. The check valve 130 is in inline fluid communication with the hydrogen ports 114. In one embodiment, a second check valve is integrated into the lid of the cartridge housing 105. The check valve 130 may be a silicone duckbill type valve, or a diaphragm type valve such as those supplied by United States Plastics of Lima, Ohio.

In one embodiment, a hydrogen pressure sensor 132 downstream from the check valve 130 measures the gas pressure of the hydrogen. In a further embodiment, the hydrogen pressure sensor 132 measures the hydrogen pressure in the system upstream of the hydrogen regulator 142. The hydrogen pressure sensor 132 may be used for safety purposes and/or to monitor hydrogen generation rates. In one embodiment, the electrical and control system 103 may use the pressure values measured by the hydrogen pressure sensor 132 to determine a pump pulse rate for the water pump 126 using a pressure curve, as described above. In general, the electrical and control system 103 may increase the pulse rate for low pressure measurements, and decrease the pulse rate for high pressure measurements. More curves, such as power demand or other curves, may also be factored into determining an optimal pulse rate. Monitoring the pressure using the pressure sensor 132 also allows the system 100 to adjust the pressure before it reaches unsafe levels. If pressure is above a predetermined safety value, the electrical and control system 103 may vent hydrogen out through the hydrogen purge valve 166 to return the system to a safe pressure.

In one embodiment, the mechanical valve 133 is positioned upstream of the hydrogen pressure regulator 142. In one embodiment, the mechanical valve 133 is a mechanical valve configured to automatically release gas pressure when the pressure is greater than a predetermined pressure. In one embodiment, the predetermined pressure associated with the mechanical valve 133 is higher than the predetermined safety value associated with the hydrogen pressure sensor 132 described above. In one embodiment, the predetermined pressure associated with the mechanical valve 133 is about 24 pounds per square inch gauge (psig), and the predetermined safety value associated with the hydrogen pressure sensor 132 is between about 25 to 30 psig or higher depending on system design requirements, such as 100 psig.

In one embodiment, one or more other system components are configured to release hydrogen pressure in the event that the hydrogen pressure regulator 142 fails. The other system components may include o-rings, hose fittings or joints, the water pump 126, or other mechanical components or connections. The multiple levels of pressure release provides added safety to the user, and ensures that the system 100 remains at a safe pressure, with no danger of explosions or other damage to the system 100 or to the user. Low pressure systems are not only safer than higher pressure systems, but in general they have lower material and construction costs.

In one embodiment, the water reservoir 128 has a water condenser 138. The water condenser 138 removes water from air and other gasses that enter the water reservoir 128. In one embodiment, water condenses on frit or other material in the condenser. In a further embodiment, the air and other gases exit the system through the pressure control valve 140 after passing through the condenser 138.

In one embodiment, the hydrogen passes from the hydrogen processing system 116 to the hybrid hydrogen fuel cell system 102. In one embodiment the hybrid hydrogen fuel cell system 102 has a hydrogen pressure regulator 142, a hydrogen pressure sensor 144, a hydrogen fuel cell stack assembly 146, one or more air filters 150, one or more air pumps 152, an air humidifier 156, a modular stack 158, a hydrogen humidifier 160, one or more cooling fans 162, a temperature sensor 164, a hydrogen purge valve 166, and one or more power storage devices 168.

In one embodiment, the hydrogen regulator 142 regulates the flow of hydrogen into the hydrogen fuel cell stack assembly 146 from the hydrogen processing system 116. The hydrogen regulator 142 cooperates with the check valve 130 to store hydrogen between the check valve 130 and the hydrogen regulator 142, even between uses of the system 100. The hydrogen regulator 142 releases a controlled amount of hydrogen into the fuel cell stack assembly 146, maintaining a predetermined gas pressure in the fuel cell 146. In one embodiment, the predetermined gas pressure in the fuel cell 146 is about 7 psi.

In one embodiment, the hydrogen pressure sensor 144 measures the gas pressure of the hydrogen in the system 100 downstream of the hydrogen regulator 142. (i.e. within the fuel cell system 102). The hydrogen pressure sensor 144 may be used for safety purposes, and/or to monitor hydrogen use by the fuel cell 146. If pressure is above a predetermined safety value, hydrogen may be vented from the system through the hydrogen purge valve 166 to return the pressure to a safe level. In one embodiment, if the pressure is below the predetermined fuel cell gas pressure described above, the hydrogen regulator 142 releases more hydrogen into the fuel cell stack 146.

The hydrogen fuel cell stack assembly 146 creates electric power from a flow of hydrogen and air, as is known in the art. In general, each fuel cell 158 in the hydrogen fuel cell stack assembly 146 has a proton exchange membrane (PEM), an anode, a cathode, and a catalyst. A micro-layer of the catalyst is usually coated onto carbon paper, cloth, or another gas diffusion layer, and positioned adjacent to the PEM, on both sides. The anode, the negative post of the fuel cell 158, is positioned to one side of the catalyst and PEM, and the cathode, the positive post of the fuel cell, is positioned to the other side. The hydrogen is pumped through channels in the anode, and oxygen, usually in the form of ambient air, is pumped through channels in the cathode. The catalyst facilitates a reaction causing the hydrogen gas to split into two H+ ions and two electrons. The electrons are conducted through the anode to the external circuit, and back from the external circuit to the cathode. The catalyst also facilitates a reaction causing the oxygen molecules in the air to split into two oxygen ions, each having a negative charge. This negative charge draws the H+ ions through the PEM, where two H+ ions bond with an oxygen ion and two electrons to form a water molecule.

In one embodiment, one or more air filters 150 are configured to filter air for use by the fuel cell stack assembly 146. In one embodiment, one or more air pumps 152 draw air into the system 100 through the air filters 150. The air pumps 152 may be diaphragm pumps, or other types of air pumps capable of maintaining an air pressure to match the hydrogen pressure in the fuel cell, for a maximum power density in the fuel cell stack 146. In one embodiment, the air pumps 152 are configured to increase or decrease the air flow in response to a signal from the electrical and control system 103. The electrical and control system 103 may send the activating signal in response to a determined electrical load on the system 100. Varying the air flow as a function of the electrical load reduces parasitic power losses and improves system performance at power levels below the maximum. In one embodiment, the one or more air pumps 152 have multiple air pumping capabilities configured to optimize the amount of air delivered to the fuel cell stack 146. For example, a smaller capacity air pump 152 may be activated during a low power demand state, a larger capacity air pump 152 may be activated during a medium power demand state, and both the smaller and the larger capacity air pumps 152 may be activated during a high power demand state.

In one embodiment, the air humidifier 156 humidifies the air entering the fuel cell stack 146. Adding moisture to the air keeps the PEMs in each of the fuel cells 158 moist. Partially dehydrated PEMs decrease the power density of the fuel cell stack 146. Moisture decreases the resistance for the H+ ions passing through the PEM, increasing the power density. In one embodiment, moist air exiting the fuel cell stack 146 flows past one side of a membrane within the air humidifier 156 before exiting the fuel cell stack 146, while dry air flows past the other side of the membrane as the dry air enters the fuel cell stack 146. Water is selectively drawn through the membrane from the wet side to the dry side, humidifying the air before it enters the fuel cell stack 158.

In one embodiment, the hydrogen humidifier 160 is configured to humidify the hydrogen entering the fuel cell stack 146, such that the PEM remains moist. This is useful if the fuel cell stack 146 is being run at a very high power density, or at a very high temperature, and the moisture already in the hydrogen is not enough to keep the PEM moist. The hydrogen humidifier 160 may be configured in a similar manner as the air humidifier 156, with hydrogen flowing into the fuel cell stack 146 on one side of a membrane within the hydrogen humidifier 160, and moist air flowing out of the fuel cell stack 146 on the other side of the membrane, the membrane selectively allowing water to pass through to humidify the hydrogen. The moist hydrogen will moisten the anode side of the PEMs, while the moist air from the air humidifier 156 will moisten the cathode side of the PEMs.

In one embodiment, the one or more cooling fans 162 prevent the fuel cell stack 158 from overheating. The electrical and control system 103 controls the operation and speed of the cooling fans 162. Separating the cooling system 162 from the fuel cell stack air supply system decreases the dehydration of the PEM since the air supply can be kept at a much lower flow than is required for cooling. A fuel cell system with separated cooling and air supply systems are referred to as closed cathode systems. In one embodiment, the cooling fans 162 are low power fans that provide high airflows. In a further embodiment, the airflow from the cooling fans 162 may be adjusted according to the temperature of the fuel cell stack 158 to reduce parasitic power losses. In another embodiment, the one or more cooling fans 162 comprise one or more blowers configured to maintain a higher air pressure than an axial fan. One or more forms, guides, ducts, baffles, manifolds, or heat dams may be used to control and direct the flow of air, or to maintain a predefined air pressure in and around the fuel cell stack 146.

In one embodiment, the temperature sensor 164 measures the temperature of the fuel cell stack 162. As described above, in one embodiment the cooling fans 162 may be activated based at least in part on the temperature that the temperature sensor 164 measures. In a further embodiment, the electrical and control system 103 is configured to shutdown the system 100 and to notify the user if the temperature sensor 164 measures a temperature higher than a predetermined unsafe temperature value.

In one embodiment, a hydrogen purge valve 166 is coupled to the fuel cell stack 146. The hydrogen purge valve 166 vents hydrogen from the fuel cell stack 146. The hydrogen purge valve 166 may be used to vent hydrogen when pressures reach unsafe levels, as measured by the hydrogen pressure sensors 132, 144 described above, or routinely to keep the fuel cells 158 in good condition by removing extra water or impurities to prevent corrosion of the catalyst. The electrical and control system 103 may send a purge signal to the hydrogen purge valve 166 when the pressure reaches an unsafe level, or when the electrical power produced by the fuel cell stack 146 is below a predefined level. In one embodiment, the hydrogen exiting the fuel cell stack 158 through the hydrogen purge valve 166 and the moist air that has exited the fuel cell stack 158 are sent to the water reservoir 128 and passed through the water condenser 138 to recycle the water formed in the reaction in the fuel cell stack 146 for reuse.

In one embodiment, one or more power storage devices 168 are coupled electrically to the fuel cell stack 146. In one embodiment, the power storage devices 168 are rechargeable, and are trickle-charged by the fuel cell stack 146 when it is not in use or after the load has been disconnected to use up excess hydrogen produced by the system 100 during shutdown. The power storage devices 168 provide instantaneous power to the load during a startup phase for the system 100. This means that a load connected to the system 100 will have instantaneous power, and will not have to wait for the hydrogen generation system 101 to begin generating hydrogen, or for the fuel cell stack 146 to begin producing electricity before receiving power.

In one embodiment, the power storage devices 168 are configured to heat the fuel cell stack 146 in cold environments to allow rapid startup of the fuel cell stack 146. The power storage devices 168 may heat the fuel cell stack 146 using a heating coil or other heated wire, or by using another electric heating method. In one embodiment, the power storage device 168 is coupled to the fuel cell stack 146 in parallel, and acts to level the load on the fuel cell stack 146 so that the fuel cell stack 146 can operate at its most efficient power level without constantly varying its output based on the load. The power storage devices 168 will supplement the power generated by the fuel cell stack 146 during a spike in the electrical power drawn by the load. The power storage devices 168 may be selected from a group consisting of batteries, such as sealed lead acid batteries, lithium ion (Li-ion) batteries, nickel metal hydride (NiMH) batteries, or a variety of rechargeable batteries, a capacitor, a super capacitor, and other devices capable of storing electric power. In one embodiment, power storage devices 168 are selected for use with power capacities that may be larger than are necessary to supplement the fuel cell stack 146 in order to avoid deep cycling of the power storage devices 168 and to increase the life of the power storage devices 168.

In one embodiment, the electrical and control system 103 is coupled for electrical power and control signal communication with the sensors, valves, and other components of the system 100. In one embodiment, the electrical and control system 103 includes one or more voltage and current sensors 170, a direct current (DC) to DC converter 172, a circuit breaker 174, a ground fault circuit interrupter (GFCI) device 176, an electronic switch 178, a DC outlet 180, an AC inverter 181, an AC outlet 182, a circuit breaker switch 184, a GFCI switch 186, a display 188, a keypad 190, a control system 192, a computer communication interface 194, and a control bus 196.

In one embodiment, the voltage and current sensors 170 are configured to measure the voltage and the current at both poles of the power storage device 168. The electrical and control system 103 uses the voltage and the current at each pole of the power storage device 168 to determine the charge level of the power storage device 168. Based on the measurements of the voltage and current sensors 170 the electrical and control system 103 determines whether to charge the power storage device 168 or draw on the power storage device 168 to supplement or proxy for the fuel cell stack 146. The electrical and control system 103 also provides the power status of the battery to the user.

In one embodiment, the DC to DC converter 172 is configured to convert the variable voltage of the fuel cell stack 146 circuit to a substantially constant voltage. In one embodiment, the substantially constant voltage is a standard voltage, such as 9 Volts, 12 Volts, 14 Volts, or the like. In one embodiment, a voltage regulator may be used in place of the DC to DC converter 172. In general, use of the DC to DC converter 172 results in less power loss than a voltage regulator. The DC to DC converter 172 may provide electric power to the electrical components of the system 100 and to an electrical load that is coupled to the system 100.

In one embodiment, the circuit breaker 174 interrupts the electric circuit in response to an overload in the circuit. An overload in the circuit may occur if the electrical load requires more current than the system 100 can provide. In one embodiment, the rating of the circuit breaker 174 is determined by the electric power generating capabilities of the system 100. In one embodiment, the circuit breaker 174 is a standard rated circuit breaker rated for the current level of the electrical and control system 103. In one embodiment, the circuit breaker switch 184 is configured to reset the circuit breaker 174 after the circuit breaker 174 interrupts the circuit.

In one embodiment, the GFCI device 176 interrupts the electric circuit in response to an electrical short in the circuit. The GFCI device 176 can interrupt the electric circuit more quickly than the circuit breaker 174. The GFCI device 176 is configured to detect a difference in the amount of current entering the circuit and the amount of current exiting the circuit, indicating a short circuit or current leak. In one embodiment, the GFCI device 176 is able to sense a current mismatch as small as 4 or 5 milliamps, and can react as quickly as one-thirtieth of a second to the current mismatch. In one embodiment, the GFCI switch 186 is configured to reset the GFCI device 176 after the GFCI device 176 interrupts the circuit.

In one embodiment, electronic switch 178 disconnects the load from electric power, without disconnecting the rest of the circuit. In one embodiment, the electronic switch 178 disconnects the load after a user initiated a power down phase of the system. During a shutdown state, the system 100 may activate the electronic switch 178, disconnect the load, continue to generate electricity to charge the power storage device 168, and use excess hydrogen.

In one embodiment, the DC outlet 180 provides an outlet or plug interface for supplying DC power to DC devices. In one embodiment, the DC power has a standard DC voltage. In one embodiment, the standard DC voltage is about 9 to 15 Volts DC. In a further embodiment, the DC outlet 180 is a “cigarette lighter” type plug, similar to the DC outlets found in many automobiles.

In one embodiment, the AC inverter 181 converts DC power from the DC to DC converter 176 to AC power. In one embodiment, the AC inverter 181 converts the DC power to AC power having a standard AC voltage. The standard AC voltage may be chosen based on region, or the intended use of the system 100. In one embodiment, the standard AC voltage is about 110 to 120 Volts. In another embodiment, the standard AC voltage is about 220 to 240 Volts. In one embodiment, the AC inverter 181 converts the DC power to AC power having a standard frequency, such as 50 Hz or 60 Hz. The standard frequency may also be selected based on region, or by intended use, such as 16.7 Hz or 400 Hz.

In one embodiment, the AC outlet 182 provides an outlet or plug interface for supplying AC power from the AC inverter 181 to AC devices. In one embodiment, the AC outlet 182 is configured as a standard AC outlet according to a geographical region.

In one embodiment, the display 188 is configured to communicate information to a user. The display 188 may be a liquid crystal display (LCD), a light emitting diode (LED) display, a cathode ray tube (CRT) display, or another display means capable of signaling a user. In one embodiment, the display 188 is configured to communicate error messages to a user. In a further embodiment, the display 188 is configured to communicate the amount of power stored by the power storage device 168 to a user. In another embodiment, the display 188 is configured to communicate the usage status of the hydrogen fuel cartridge 106 to a user.

In one embodiment, the keypad 190 is configured to receive input from a user. In one embodiment, the user is a technician, and the keypad 190 is configured to facilitate system error diagnosis or troubleshooting by the technician. The input may be configured to signal the system 100 to begin a start up or shut down phase, to navigate messages, options, or menus displayed on the display 188, to signal the selection of a menu item by the user, or to communicate error, troubleshooting, or other information to the system 100. The keypad 190 may comprise one or more keys, numeric keypad, buttons, click-wheels, or the like.

In one embodiment, the control system 192 is configured to control one or more components of the system 100. The control system 192 may be an integrated circuit such as a micro-processor, an application specific integrated circuit (ASIC), a field programmable gate array (FPGA), an embedded controller, or the like and related control circuitry. The control system 192 communicates with the hydrogen pressure sensor 132, the temperature sensor 118, the RFID sensor 124, the optical sensor 120, the water injection pump 126, the level detector 129, the air pump 152, the hydrogen pressure sensor 144, the electrical sensors 170, the temperature sensor 164, the display 188, the keypad 190, and/or other components.

In one embodiment, the control system 192 uses a control bus 196 to communicate with the components. The control bus may be one or more wires, or another communications medium providing control commands and data in series or parallel. The control system 192 may communicate on the bus using digital or analog communications. The control system 192 may monitor and optimize system efficiency and system safety, as discussed above. In one embodiment, the control system 192 may store one or more system status messages, performance data, or statistics in a log that may be accessed by a user using the display 190 or the computer communication interface 194. In one embodiment, the control system 192 and other circuitry are positioned to prevent shorts and fire due to water within the outer housing 104. For example, in one embodiment, the control system 192 and other circuitry are positioned towards the top of the system 100.

In one embodiment, the computer communication interface 194 is configured to interface the control system 192 with a computer. The computer communication interface 194 may comprise one or more ports, terminals, adapters, sockets, or plugs, such as a serial port, an Ethernet port, a universal serial bus (USB) port, or other communication port. In one embodiment, a computer may use the computer communication interface 194 to access system logs, performance data, system status, to change system settings, or to program the control system 192.

In one embodiment, the outer housing 104 is configured to enclose and protect the system 100. The outer housing 104 comprises a durable material such as metal, plastic, and the like. In one embodiment, the outer housing 104 is a lightweight material to increase the portability of the system 100. In a further embodiment, the outer housing 104 has a hole or a window to facilitate monitoring of the water level in the water reservoir 128 by the user. In a further embodiment, the housing 104 is further configured to provide electronic frequency shielding to components of the electric and control system 103.

FIG. 2 illustrates one embodiment of a hydrogen fuel cartridge 200 that is substantially similar to the hydrogen fuel cartridge 106 of FIG. 1. The fuel cartridge 200 may include a tubular body or housing 202, which in one embodiment may range from about 1 to 5 inches in diameter and from about 4 to 12 inches in length. The housing 202 is not limited to any particular cross-sectional shape or any particular dimensions, but may have a circular cross-sectional shape.

In one embodiment, the housing 202 is formed of a material such as aluminum which has sufficient strength, is comparatively light, and has good heat transfer characteristics. However, many substitute materials will be readily apparent to those skilled in the art, including steel, stainless steel, copper, carbon fiber epoxy composites, fiberglass epoxy composites, PEEK, polysulfone derivatives, polypropylene, PVC, or other suitable materials. In one embodiment, the fuel cartridge 200 also has a top end cap 204 allowing the fuel cartridge 200 to be easily positioned and locked into place with other components of the overall hydrogen generation system 100 as described above.

In one embodiment, the top end cap 204 includes an alignment structure 208, one or more hydrogen ports 212, and one or more water ports 216. In one embodiment, the hydrogen ports 212 and the water ports 216 may also comprise one or more self sealing devices known to those skilled the art. The alignment structure 208 or other locking feature is configured to ensure that the top end cap 204 can only engage the lid of the cartridge housing 105 in one orientation. In one embodiment, the housing 202 includes a crimp 224, substantially circumscribing the housing 202 near the open end of the housing 202. The crimp 224 secures the housing 202 to the top end cap 204. In addition, the crimp 224 is configured to release internal hydrogen gas and water in response to a dangerously high gas pressure build up within the housing 202. In further embodiments, other securing methods such as threading, glue or other adhesives, welding, or the like may secure the top end cap 204 to the housing 202.

In one embodiment, the one or more hydrogen ports 212 and the one or more water ports 216 are substantially similar to the one or more hydrogen ports 114 and the one or more water ports 111 described above. In one embodiment, the inside diameters of hydrogen ports 212 and the water ports 216 are about one sixteenth of an inch. In one embodiment, one or more fluid injection tubes 218 extend into the interior of the cartridge housing 202 which holds a solid reactant (as explained in more detail below) from the one or more water ports 216. In one embodiment, the injection tubes 218 may extend into the housing 202 at least half of the length of the housing 202, in other embodiments the injection tubes 30 may extend less than half the housing's length. In one embodiment, the water injection tubes 218 have an inside diameter of about 1 mm. In a further embodiment, the water injection tubes 218 have an inside diameter ranging from about 0.5 to 5.0 mm.

The injection tubes 218 may be made of aluminum, brass, or other metal, PTFE, Nylon®, or other high temperature polymers. In one embodiment, a series of liquid distribution apertures will be formed along the length of the water injection tubes 218. In another embodiment, the cartridge 200 is oriented vertically, and the injection tubes 218 are configured to extend substantially to the base of the cartridge 200, such that water successively fills the cartridge 200 from the base towards the top end cap 204. In this manner the water may also be pumped out of the cartridge 200 through the injection tubes 218 to further control hydrogen production and to maintain a safe hydrogen pressure.

FIG. 3A illustrates a further embodiment of a fuel cartridge 300. As suggested above, one embodiment of the fuel cartridge 300 will contain a solid reactant such as an anhydrous chemical hydride. In one embodiment, a chemical hydride may be considered a reducing compound containing a metal and hydrogen that generates hydrogen gas when it reacts with water or other oxidizing agents. Various examples of chemical hydrides are disclosed in U.S. application Ser. No. 10/459,991 filed Jun. 11, 2003 which is incorporated herein by reference. Nonlimiting examples of chemical hydrides may include sodium borohydride, lithium borohydride, lithium aluminum hydride, lithium hydride, sodium hydride, and calcium hydride.

In one embodiment, the chemical hydride reactant is enclosed within a water permeable material, or fabric pouch 302. As used herein, “fabric” includes not only textile materials, but also includes paper based porous materials that may be used for filtration purposes. One embodiment of the fabric comprises a porous material which can maintain structural integrity at temperatures ranging from about −20° C. to about 200° C., and a pH ranging from about 4 to about 14.

Suitable fabrics may include but are not limited to woven or nonwoven Nylon, Rayon, polyester, porous filter paper, or blends of these materials. In one embodiment, the material for the pouch 302 may be selected for optimal thickness, density, and water retention. In one embodiment, the cartridge 300 is in a vertical configuration and the pouch 302 comprises a material with minimal water retention, such that the weight of the water retained is less than about 10 times the weight of the material itself. The material also includes little or no wicking capabilities. In a further embodiment, the cartridge 300 is in a horizontal configuration and a material 302 is selected with a greater water retention ability and some wicking ability.

The water retention and wicking potential of the pouch 302 affect where the chemical reaction between the water and the chemical hydride occurs. Low water retention and wicking potential helps keep the chemical reaction at or below the water fill level in the cartridge 300. If the water retention and wicking potential are higher, the pouch 302 wicks and retains the water such that the chemical reaction can occur above the fill level of the cartridge 300. Selection of a material for the pouch 302 may be based on the configuration of the cartridge 300, the injection tubes 304, and the chemical hydride and activating agent in use, in order to more precisely control the chemical reaction within the cartridge 300.

Other relevant factors may include water permeability, porosity, chemical reactivity, and temperature stability between about 150° C. and about 250° C. relative to the chemical hydride, activating agent, and water injection system 304 in use. A suitable thickness for the material for the pouch 302 is between about 0.002 inches and 0.01 inches. A suitable density is less than about 0.05 grams per square inch.

In one exemplary embodiment, the pouch 302 comprises Crane® 57-30, a product of Crane Nonwovens of Dalton, Mass. Crane® 57-3030 has a thickness of about 0.0043 inches, has a density of about 57.9 grams per square meter, is water permeable, has a pore size below about 0.0025 inches, is chemically resistant in basic and acidic solutions of about pH 4 to about pH 13, is stable in temperatures up to about 180° C., and retains only about 7.5 times its own weight in water. Other combinations of material properties such as thickness, density, and water retention that are configured for stable hydrogen generation may also be used.

In one embodiment, the fabric pouch 302 is comparatively thin having a substantially greater area than thickness. The pouch 302 may be formed in any conventional manner. For example, viewing FIG. 3B, it can be seen how two rectangular sheets of fabric material 314 and 316 may be sealed along three edges (for example by stitching 310 or other sealing methods) and segmented into 0.25 to 2 inch sections 318 (also by stitching) to leave open ends 312. The series of sections 318 thus formed are filled with a fine grain chemical hydride (described below) and sealed along the fourth edge by stitching closed open ends 312.

An illustrative thickness of the pouch 302 (i.e., the thickness of sections 318 when unrolled and charged with a chemical hydride) may be approximately ¼ of an inch in one embodiment and its unrolled dimensions could be approximately 5.75 inches by 20 inches. Then the pouch 302 is rolled to a diameter sufficiently small to be inserted into tubular housing 300 as suggested in FIG. 3A (the top end cap 206 has been removed for purposes of clarity). The thickness of the pouch 302 and the unrolled dimensions may be determined based on the size of the cartridge 300, and the configuration of the pouch 302. The water injection tubes 304 are then carefully inserted between overlapping layers of the rolled pouch 302. In one embodiment, a liner (not shown) is also disposed within the housing 300 to protect the housing from corrosion and damage. The liner may be removable or permanent, and may serve to extend the life of the housing 300. In one embodiment, the liner is a bag or pouch consisting of a plastic or other inert material known in the art, and the liner is configured to withstand the temperatures associated with a hydrogen-generating chemical reaction, and to protect the cartridge 300 from corrosion.

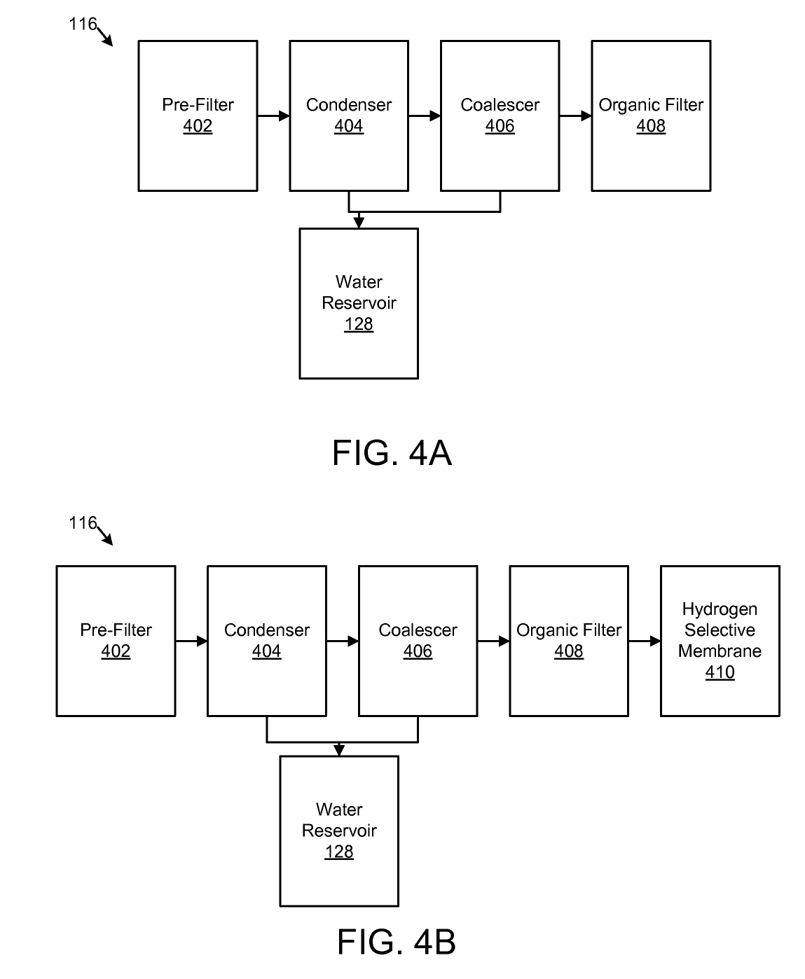

FIG. 4A illustrates one embodiment of a hydrogen processing system 116. The hydrogen processing system 116 includes a pre-filter 402, a condenser 404, a coalescer element 406, and an organic filter 408. The hydrogen processing system 116 is configured to remove impurities such as hydrocarbons or other organic compounds, water vapor, dissolved or solid salts, or other impurities from the generated hydrogen gas. Purifying the hydrogen protects other components that pass or use the hydrogen such as valves, conduits, PEM fuel cells, and the like. In addition, purified hydrogen may allow components such as PEM fuel cells to operate more efficiently and at higher flow rates.

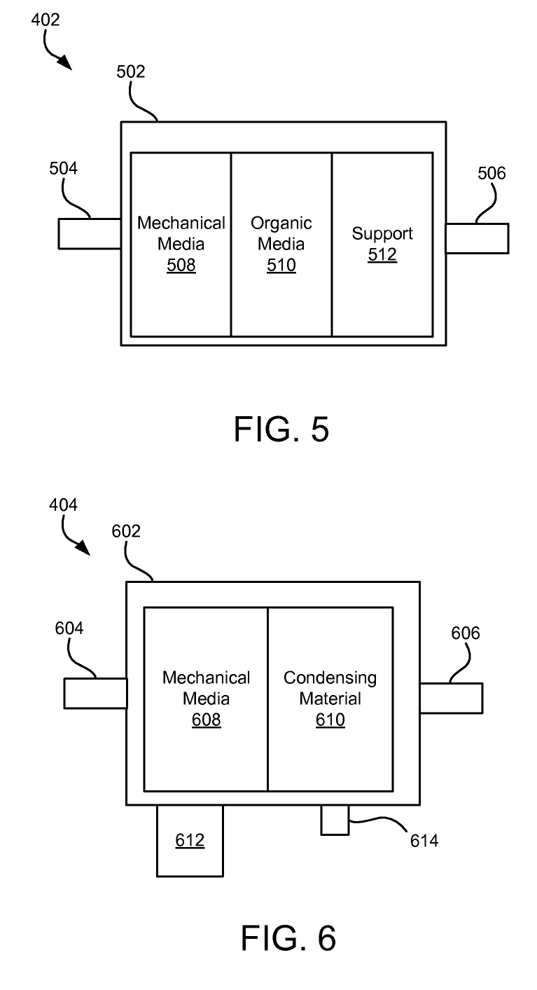

The pre-filter 402, in one embodiment, collects contaminants suspended within a flow of hydrogen gas through one or more of mechanical filtration, organic filtration, surface adsorption, chemical reaction, and other means of filtration. The pre-filter 402 may include a support structure that supports other elements of the pre-filter 402. Certain embodiments of a pre-filter 402 are described in relation to FIG. 5.

In one embodiment, the pre-filter 402 is integrated with the hydrogen fuel cartridge 106. In this manner, the pre-filter 402 is replaced when the hydrogen fuel cartridge 106 is replaced. The pre-filter 402, in one embodiment is located near the top of the hydrogen fuel cartridge 106 between the hydrogen ports 114 and the water permeable material 110. In another embodiment, the pre-filter 402 is located external to, and downstream of, the hydrogen fuel cartridge 106.

The condenser 404, in one embodiment, removes water vapor suspended within a flow of hydrogen gas. The condenser 404 condenses water vapor in the flow of hydrogen gas by converting the water from a gaseous state to a liquid state. The liquid water, in one embodiment, is removed from the condenser 404 and returned to the water reservoir 128. In certain embodiments, the water returned to the water reservoir 128 is used to generate additional hydrogen gas in the hydrogen fuel cartridge 106.

The condenser 404 may change the state of the water vapor to liquid water using any method known in the art. For example, the condenser may operate by reducing the temperature of the water vapor, by reducing the pressure of the gas, and/or by providing a condensing surface. Certain embodiments of a condenser 404 are described in relation to FIG. 6.

In one embodiment, the coalescer element 406 removes contaminants suspended within a flow of hydrogen gas. The coalescer element 406 may separate a gas contaminant phase from the hydrogen gas phase. In an alternate embodiment, the coalescer element 406 separates liquid and/or solid contaminants suspended within the flow of hydrogen gas.

In addition to separating the contaminant, the coalescer element 406 conglomerates smaller portions of separated contaminant in one embodiment. Contaminants may coalesce to be captured as droplets by the coalescer element 406. The coalescer element 406 may cause the droplets of contaminants to grow to form larger droplets of contaminants or even larger pools of contaminants. In one embodiment, the coalescer element 406 causes the pools of contaminants to grow as the coalescer element 406 operates on a flow of hydrogen gas. In certain embodiments, the inside of the coalescer element 406 is coated with a hydrophilic compound, while the outside of the coalescer element 406 is coated with a hydrophobic compound. The hydrophilic compound tends to collect liquid water, while the hydrophobic compound tends to repel liquid water. Liquid water will collect on the hydrophilic inside of the coalescer element 406. As pressure pushes the collecting water droplets out, the droplets then come into contact with the hydrophobic material. Because the hydrophobic material repels the water droplets, the water droplets collect into larger droplets. These larger droplets drip out of the coalescer. The water may then drain from the center of the coalescer element 406 to the water reservoir 128.

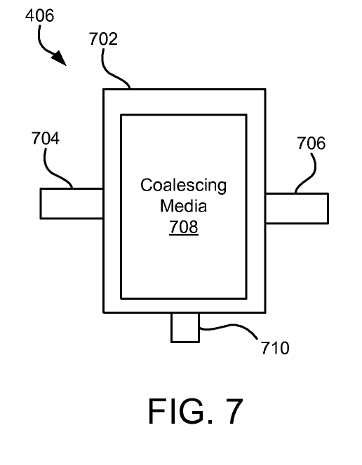

The contaminants may include gaseous or liquid water. The contaminants may further comprise salts introduced by the hydrogen generation process. These salts may be in a liquid or solid state. The salts may be suspended within the flow of hydrogen gas. The salts may be dissolved within water suspended within the flow of hydrogen gas. The salt contaminants may comprise any salt generated by the hydrogen generation process, such as metal salts or the like. Certain embodiments of a coalescer element 406 are described in relation to FIG. 7.

The organic filter 408, in one embodiment, removes organic contaminants suspended within the flow of hydrogen gas. The organic filter 408 may comprise any type of filter for collecting organic contaminants known in the art. For example, the organic filter 408 may comprise a filter with an activated carbon media. The organic filter 408 may comprise an inorganic material, an organic material, or any other material used for filtering organic contaminants.

FIG. 4B illustrates one embodiment of a hydrogen processing system 116. The hydrogen processing system 116 includes a pre-filter 402, a condenser 404, a coalescer element 406, an organic filter 408, and a hydrogen selective membrane 410. The hydrogen processing system 116 is configured to remove impurities such as hydrocarbons or other organic compounds, water vapor, dissolved or solid salts, or other impurities from the generated hydrogen gas. Purifying the hydrogen protects other components that pass or use the hydrogen such as valves, conduits, PEM fuel cells, and the like. In addition, purified hydrogen may allow components such as PEM fuel cells to operate more efficiently and at higher flow rates. The pre-filter 402, condenser 404, coalescer element 406, and organic filter 408 are preferably configured in a similar manner to like numbered components described in relation to FIG. 4A

The hydrogen selective membrane 410, in one embodiment, comprises a membrane that allows the passage of hydrogen gas and restricts the passage of other materials and gases. In one embodiment, the hydrogen selective membrane 410 is located downstream from other elements of the hydrogen processing system 116. The hydrogen selective membrane 410 may comprise a material that allows the passage of hydrogen gas and restricts the passage of other materials. For example, in one embodiment, the hydrogen selective membrane 410 may comprise a polysulfuric acid (PSA) membrane, a Nafion® membrane, or the like. Those skilled in the art recognize that passage through hydrogen-selective membranes may require low flow rates. In certain embodiments, a hydrogen selective membrane 410 two inches in diameter passes a 99.99% pure hydrogen gas stream at flow rates under about 50 cc/min. This may be sufficient to drive low power fuel cell such as a 5-watt fuel cell.

In certain embodiments, two or more components of the hydrogen processing system 116 are combined into one or more units. For example, in one embodiment, the condenser 404 and the coalescer element 406 may comprise a single unit. In another embodiment, components of the hydrogen processing system 116 may be integrated with another element of the system for generating electricity from a chemical hydride 100. For example, in one embodiment, one or more components of the hydrogen processing system 116 are located within the hydrogen fuel cartridge 106.

FIG. 5 illustrates one embodiment of a pre-filter 402 according to the present invention. The pre-filter 402, in one embodiment, includes a housing 502, an inlet 504, an outlet 506, a mechanical media 508, an organic media 510, and a support 512. The pre-filter 402, in one embodiment, removes contaminants suspended within a flow of hydrogen gas.

The housing 502, in one embodiment, confines a flow of hydrogen gas as it passes through the pre-filter 402. The housing 502 may also comprise one or more media for removing contaminants from the flow of hydrogen gas. The one or more media may be selected from those known in the art to effectively remove specific contaminants known or expected to be in the hydrogen gas stream. In certain embodiments, the housing 502 may be separate from the hydrogen fuel cartridge 106. In another embodiment, the housing 502 may be integrated with the hydrogen fuel cartridge 106. In this embodiment, the pre-filter is changed every time the hydrogen fuel cartridge 106 is changed. This helps to prevent the build-up of contaminants and the clogging of filter elements.

The one or more media may be arranged in layers such that the hydrogen gas stream passes through the layers in sequence. Each successive layer may collect different contaminants or types of contaminants. The layers may be chosen for their ability to collect specific contaminants. For example, the hydrogen gas stream may pass through an aluminum media coated with KOH to neutralize acids. The hydrogen gas stream may then pass through a cellulose fiber filtration element to collect particulate matter. The hydrogen gas stream may then pass through an activated carbon element that removes organic gases. In this example, the hydrogen gas stream exiting the pre-filter 402 may be substantially free of acids, particulate matter, and organic gases. Any of these particular contaminants in the hydrogen gas stream as received from the chemical hydride may be removed.

In certain embodiments, the pre-filter may be configured to remove both solid and gaseous contaminants. The pre-filter may include a particular filtration media appropriate to remove contaminants that are expected to be present in a hydrogen gas stream. In one embodiment, a portion of the filtration media is coated to absorb and neutralize acidic gases such as acidic halides (F₂, Cl₂, Br₂, 12), hydrogen halides (HF, HCl, HBr, HI), nitrogen oxides (NO, NO₂, N₂O, N₂O₃, N₂O₄, N₂O₅) and their acids (HNO₂, HNO₃), sulfur oxides (SO₂, SO₃) and their acids (H₂SO₃, H₂SO₄), hydrogen sulfide (H₂S), formic acid, acetic acid, and other organic acid vapors. In another embodiment, a portion such as a separate layer of the filtration media is coated to absorb volatile organic compounds such as aldehydes, ketones, ethers, alcohols, and other light hydrocarbons. One skilled in the art will recognize that the coating may be selected to ensure that the gaseous compounds expected to be present in a hydrogen gas stream are removed. Furthermore, the coatings may be placed on different portions of a single filtration media or on distinct layers of different filtration media.

The housing 502 may comprise any material capable of withstanding the pressure and heat of the hydrogen gas, such as a polymer, a metal, a composite material, or the like. For example, the housing 502 may comprise a nylon material. The housing 502 may have any shape capable of containing the components of the filter, such as a cylinder, a sphere, a cube, or the like.

The inlet 504 provides a path for the entry of hydrogen gas into the pre-filter 402. The inlet 504 may comprise any shape known in the art for an inlet, such as a tube or a channel. In one embodiment, the inlet 504 receives a flow of hydrogen gas from the hydrogen fuel cartridge 106. In certain embodiments, the inlet may be formed by machining, molding, or some other method known in the art. In some embodiments, the inlet 504 may combine a plurality of sources of hydrogen gas from a plurality of hydrogen fuel cartridges 106.

The outlet 506 provides a path for the exit of hydrogen gas from the pre-filter. The outlet 506 may comprise any shape known in the art for an outlet, such as a tube or a channel. In one embodiment, the outlet 506 is oriented opposing the inlet 504. In another embodiment, the outlet 506 is located adjacent to the inlet 504. In certain embodiments, the outlet may be formed by machining, molding, or some other method known in the art.

The pre-filter 402, in certain embodiments, includes a mechanical media 508. The mechanical media 508 may comprise pores that allow the passage of hydrogen gas, while capturing contaminants larger than the pores. In one embodiment, the pores in the mechanical media 508 are sized to capture contaminants larger than 25 microns. In another embodiment, the pores are sized to capture contaminants with a size larger than 5 microns.

In another embodiment, the pre-filter 402 may include an organic media 510. The organic media 510 removes organic contaminants such as hydrocarbons suspended within the flow of hydrogen gas. The organic filter comprises activated carbon, in one embodiment.

In one embodiment, the pre-filter 402 includes a support 512. The support 512 supports the mechanical media 508 and/or the organic media 510. The support 512 may comprise any material capable of supporting media in the pre-filter 402, such as a polymer, a metal, a composite, or the like. In one embodiment, the support 512 comprises a stainless steel mesh.

FIG. 6 illustrates one embodiment of a condenser 404 according to the present invention. The condenser 404, in one embodiment, includes a housing 602, an inlet 604, an outlet 606, a mechanical media 608, and a condensing material 610. The condenser 404, in one embodiment, removes water vapor suspended within a flow of hydrogen gas.

The housing 602, in one embodiment, confines a flow of hydrogen gas as it passes through the condenser 404. The housing 602 may also comprise one or more media for removing water vapor from the flow of hydrogen gas. The housing 602 may comprise any material capable of withstanding the pressure and heat of the hydrogen gas, such as a polymer, a metal, a composite material, or the like. For example, the housing 602 may comprise an aluminum material. The housing 602 may have any shape capable of confining the components of the filter, such as a cylinder, a sphere, a cube, or the like.

The inlet 604 provides a path for the entry of hydrogen gas into the condenser 404. The inlet 604 may comprise any shape known in the art for an inlet, such as a tube or a channel. In one embodiment, the inlet 604 receives a flow of hydrogen gas from the pre-filter 402. In some embodiments, the inlet 604 may combine multiple sources of hydrogen gas from multiple pre-filters 402.

The outlet 606 provides a path for the exit of hydrogen gas from the condenser 404. The outlet 606 may comprise any shape known in the art for an outlet, such as a tube or a channel. In one embodiment, the outlet 606 is oriented opposing the inlet 604. In another embodiment, the outlet 606 is located adjacent to the inlet 604.

The condenser 404, in certain embodiments, includes a mechanical media 608. In one embodiment, the mechanical media 608 comprises a mechanical filter element as known in the art. The mechanical media 608 may comprise pores that allow the passage of hydrogen gas, while capturing contaminants larger than the pores. In one embodiment, the pores in the mechanical media 608 are sized to capture contaminants larger than 5 microns. For example, the mechanical media 608 may comprise a polyester material, polytetrafluoroethylene (PTFE), or the like.

The condensing material 610, in one embodiment, captures water vapor suspended within the flow of hydrogen gas as it is converted to liquid water. The condensing material 610 may also capture liquid water suspended within the flow of hydrogen gas.

In one embodiment, the condensing material 610 is a heat conductor, and the condensing material 610 is maintained at a temperature below that of the flow of hydrogen gas. In certain embodiments, the condensing material 610 conducts heat to the housing 602. For example, the condensing material may comprise a stainless steel mesh.

The housing 602 may be cooled using air, water, or another fluid as known in the art. In one embodiment, the condenser 404 includes a fluid circulation device 612 that circulates a fluid across the surface of the housing 602 to cool the surface of the housing 602. As the hydrogen gas comes in contact with the cooled condensing material 610, water vapor suspended within the flow of hydrogen gas condenses on the condensing material 610.

As will be appreciated by one skilled in the art, the fluid circulation device 612 may comprise any device used to move fluids for cooling. For example, the fluid circulation device 612, in one embodiment, may comprise a blower. In another embodiment, the fluid circulation device 612 may comprise a fan, a pump, or the like.

Liquid water, in one embodiment, flows along the condensing material 610 and collects in the bottom of the housing 602. In one embodiment, the water is removed from the housing 602 through a water port 614. In a certain embodiment, the water port 614 delivers the water to a water reservoir 128. One skilled in the art will recognize that the water can be drawn to the water reservoir 128 by gravity, applied pressure, or by other forces. If gravity is the driving force selected, the orientation of the apparatus may be such that the water can flow toward the water reservoir 128.

FIG. 7 illustrates one embodiment of a coalescer element 406 according to the present invention. The coalescer element 406, in one embodiment, includes a housing 702, an inlet 704, an outlet 706, and a coalescing media 708. The coalescer element 406, in one embodiment, removes liquid from the flow of hydrogen gas. The liquid may contain contaminants that are dissolved in the liquid.

The housing 702, in one embodiment, confines a flow of hydrogen gas as it passes through the coalescer element 406. The housing 702 may also comprise one or more media for coalescing contaminants from the flow of hydrogen gas. The housing 702 may comprise any material capable of withstanding the pressure and heat of the hydrogen gas, such as a polymer, a metal, a composite material, or the like. For example, the housing 702 may comprise a nylon material, such as the model 710N manufactured by United Filtration of Sterling Heights, Mich. The housing 702 may have any shape capable of confining the components of the filter, such as a cylinder, a sphere, a cube, or the like.

The inlet 704 provides a path for the entry of hydrogen gas into the coalescer element 406. The inlet 704 may comprise any shape known in the art for an inlet, such as a tube or a channel. In one embodiment, the inlet 704 receives a flow of hydrogen gas from the condenser 404. In some embodiments, the inlet 704 may combine multiple sources of hydrogen gas from multiple condensers 404.

The outlet 706 provides a path for the exit of hydrogen gas from the coalescer element 406. The outlet 706 may comprise any shape known in the art for an outlet, such as a tube or a channel. In one embodiment, the outlet 706 is oriented opposing the inlet 704. In another embodiment, the outlet 706 is located adjacent to the inlet 704.

The coalescing media 708, in one embodiment, separates contaminants from the flow of hydrogen gas through the coalescer element 406. The coalescing media 708 may comprise a hydrophilic layer that attracts droplets of water in the flow of hydrogen gas 708. For example, the coalescing media 708 may comprise a borosilicate filter element.

The droplets of water in the flow of hydrogen gas may comprise other contaminants, such as dissolved salts produced in the generation of hydrogen from a chemical hydride. As water coalesces, the water acts as a filtration element. As the hydrogen gas stream passes through the coalescer element, solid and liquid particles may impinge on liquid water and collect in the liquid water. In addition or alternatively, the solid particles may provide a source or seed that promotes the condensation that forms the liquid water. The solid and liquid particles may or may not be soluble in water. The soluble contaminants may dissolve into the water droplets, while the insoluble contaminants may remain in the water as an inhomogeneous mixture. The insoluble contaminants may also settle to the bottom or drain out a water port 710. The water may further absorb gaseous contaminants that are soluble in water. For example, the water droplets may comprise an aqueous salt. The water droplets may also comprise other contaminants.

The coalescing media 708, in certain embodiments, comprises additional layers. Additional layers may be less hydrophilic than other layers in the coalescing media 708. In one embodiment, a pressure differential is generated between the layers that causes further extraction and transport of water.

In one embodiment, the droplets of water are retained by the coalescing media 708. Additional droplets of water from the flow of hydrogen gas are retained by the coalescing media 708, where the droplets coalesce together to form larger droplets. The larger droplets may further coalesce with other droplets to form pools of water.

In one embodiment, the water retained by the coalescing media 708 is drawn by gravity toward the bottom of the housing 702. The water may pool at the bottom of the housing 702. In certain embodiments, the water may be removed from the housing 702 through a water port 710. In one embodiment, water removed from the housing 702 is delivered to the water reservoir. In another embodiment, the water port 710 may deliver water from the housing 702 of the coalescer element 406 to the condenser 404. In one embodiment, the water port 710 delivers water to the condenser 404 in response to an accumulation of water in the coalescer element 406 when the system is not pressurized.

The coalescing media 708, in one embodiment, also provides mechanical filtration of the flow of hydrogen gas. In one embodiment, the coalescing media 708 comprises pores that allow for the passage of hydrogen gas while retaining larger contaminants. In one embodiment, the coalescing media 708 retains contaminants larger than 0.01 microns.

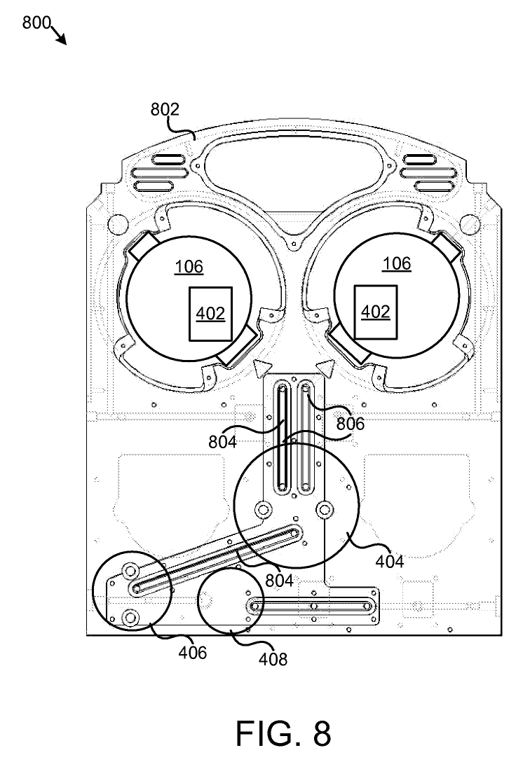

FIG. 8 illustrates one embodiment of a hydrogen generation and cleaning system 800. The hydrogen generation and cleaning system 800 includes a gas transfer system 802, a hydrogen fuel cartridge 106, a pre-filter 402, a condenser 404, a coalescer element 406, and an organic filter 408. The hydrogen generation and cleaning system 800 generates hydrogen gas from a chemical hydride and cleans the hydrogen gas by removing contaminants suspended within the gas. The hydrogen fuel cartridge 106, pre-filter 402, condenser 404, coalescer element 406, and organic filter 408 are preferably configured in a manner similar to like numbered components described in relation to FIGS. 1-7.

The gas transfer system 802, in one embodiment, routes gas generated by the hydrogen fuel cartridge 106 to other elements of the hydrogen generation and cleaning system 800. In the illustrated embodiment, the pre-filter 402 is integrated within the hydrogen fuel cartridge 106. In an alternate embodiment, the pre-filter 402 is separate from the hydrogen fuel cartridge 106 and receives hydrogen gas from the gas transfer system 802.

The gas transfer system 802 may include one or more gas ports 804 that form passages for the flow of hydrogen gas through the gas transfer system 802. In one embodiment, the one or more gas ports 804 are machined into a solid body. In an alternate embodiment, the one or more gas ports 804 are formed with a solid body. In yet another embodiment, the gas ports 804 may comprise hoses or tubes. For example, the gas passage system may comprise an injection-molded material including molded passages forming the one or more gas ports 804.

In one embodiment, the one or more gas ports 804 may include a manifold 806 that connects two or more hydrogen sources to the other components of the hydrogen generation and cleaning system 800. For example, in the illustrated embodiment, the hydrogen generation and cleaning system 800 includes two hydrogen fuel cartridges 106 connected through a manifold 806 to a single condenser 404.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

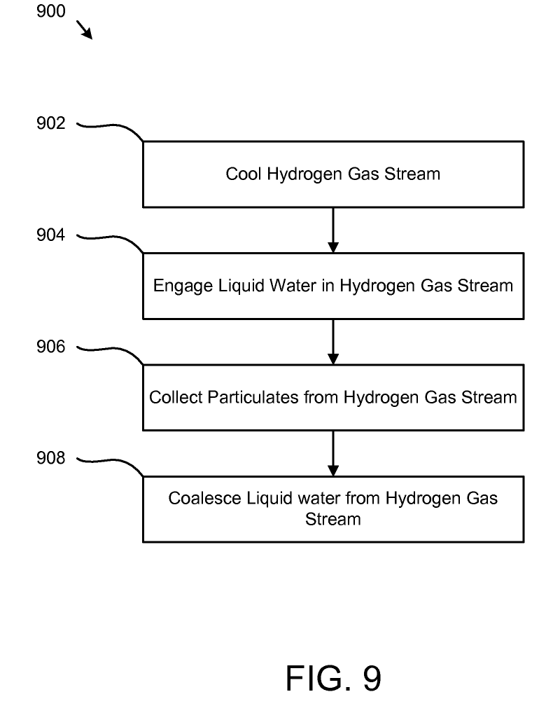

FIG. 9 is a flow chart diagram showing the various steps of a method 900 for cleaning hydrogen gas generated from a chemical hydride. The method 900 is, in certain embodiments, a method of use of the system and apparatus of FIGS. 1-8, and will be discussed with reference to those figures. Nevertheless, the method 900 may also be conducted independently thereof and is not intended to be limited specifically to the embodiments discussed above with respect to those figures.

As shown in FIG. 9, the method begins and a condenser 404 cools 902 the hydrogen gas stream. Liquid water within the hydrogen gas stream is engaged 904. Engaging 904 may take place on a condensing material 610 in the condenser 404. In a further embodiment, engaged 904 water is removed from the condenser 404 and returned to a water reservoir 128.

A mechanical filtration element may collect 906 particulate matter from the hydrogen gas stream. The coalescer element 406 coalesces 908 substantially all liquid water suspended within the flow of hydrogen gas. Coalescing 908 may take place on a coalescing media 708. The coalescing media 708 may coalesce 908 droplets of contaminants that coalesce 908 into larger droplets and pools of water. The coalesced 908 water may comprise other contaminants, such as salts dissolved within the water. In certain embodiments, coalesced 908 water is returned to a water reservoir 128. The hydrogen gas stream may then be delivered 910 to a point of use, such as a fuel cell, or a storage device.

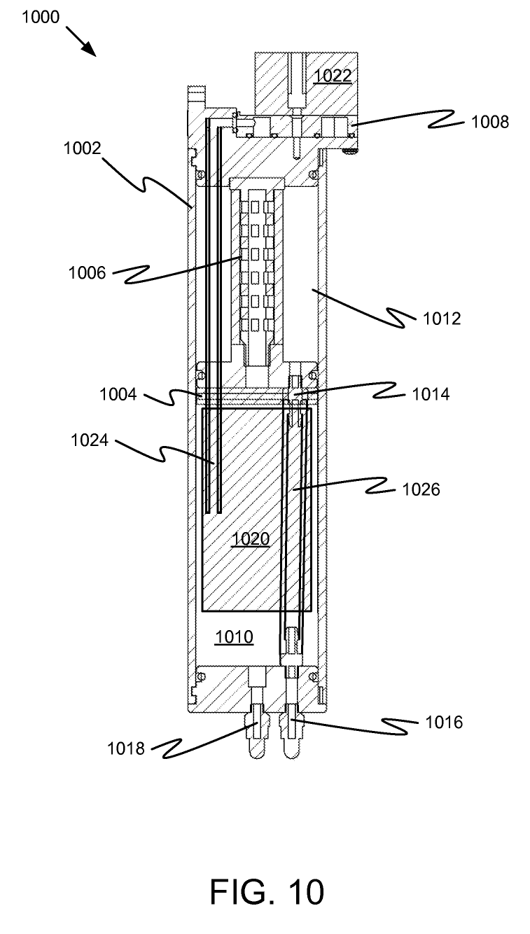

FIG. 10 illustrates one embodiment of an apparatus 1000 for processing a hydrogen gas stream in accordance with the present invention. In this embodiment, the housing 1002 holds a condensing media 1020, a mechanical filtration element 1004, a coalescer element 1006, and an outlet port (not shown). Pre-filtration of the hydrogen gas stream may be performed before the hydrogen gas stream enters the apparatus. In certain embodiments, the pre-filtration is performed within a hydrogen fuel cartridge 106. The housing 1002 comprises a heat- and pressure-resistant material. One of skill in the art will recognize that the operating conditions required will affect the material chosen for the housing. In certain embodiments, the housing 1002 can be made of metal, plastic, or other materials. The material for the housing 1002 may be selected for corrosion resistance if the hydrogen gas stream is expected to include corrosive constituents.

In one embodiment, the apparatus 1000, includes a condenser 1008 that absorbs heat from the hydrogen gas stream and thereby also condenses water from the hydrogen gas stream. The condenser 1008 may have a channel that passes the hydrogen gas stream through the condenser 1008. As the hydrogen gas stream passes through the channel, water condenses on the wall of the channel because the hydrogen gas stream is cooling. In one embodiment, this condensed water is pushed through the channel by the hydrogen gas stream farther into the apparatus 1000, where the condensed water is collected. A bypass tube 1024 may carry the hydrogen gas stream to a condenser chamber 1010. The bypass tube 1024 may carry the hydrogen gas stream into the condensing media 1020. The material for the condenser 1008 may be selected for corrosion resistance if the hydrogen gas stream is expected to contain corrosive constituents. In one embodiment, the condenser is made of a material with a heat conductivity greater than about 5 W/m·K. The condenser may be made of copper, aluminum, titanium, ceramic, carbon nanotubes, carbon- or graphite-impregnated plastics, or other materials known in the art. In one embodiment, the condenser 1008 is coated with another material to increase its resistance to corrosion.

The channel may have a round cross section, or the cross section may be any other shape known to those skilled in the art. The wall or walls of the channel define its shape. One of skill in the art will recognize that increasing the surface area of the channel increases the ability of the condenser to remove heat from the hydrogen gas stream. The length, shape, and cross section of the channel may all be modified to provide a design sufficient to provide the temperature drop required for a particular application. One of skill in the art will recognize that the condenser 1008 may serve as a heat exchanger. The condenser 1008 may be formed from a length of tubing, may be molded into a solid body, may be machined into a solid body, or the like.

The condenser 1008 may comprise a cooling module 1022 to increase the heat transfer rate. In certain embodiments, the cooling module 1022 may comprise cooling fins made of aluminum or another thermally conductive material. The cooling module may further comprise a fluid circulation device such as a cooling fan, liquid pump, or the like.

The apparatus 1000 itself may draw heat from the hydrogen gas stream, even without a condenser 1008. If the components of the apparatus 1000 have a residence time and heat transfer rate sufficient to drop the temperature of the hydrogen gas stream to the required level, a distinct condenser 1008 may not be required. One of skill in the art recognizes that the temperature drop of the hydrogen gas stream is directly proportional to the residence time and heat transfer rate. The heat transfer rate may be increased by building components of the apparatus 1000 with materials having high heat conductivity or by building fluid passages with a high surface area. Residence time may be increased by making the passages longer or by decreasing flow rates. These are some of the trade-offs that one skilled in the art can make to produce a hydrogen gas stream with a specific desired temperature. In one embodiment, the apparatus 1000 decreases the temperature of a hydrogen gas stream from 90° C. at a chemical hydride source to 60° C. for use in a fuel cell. The apparatus 1000 may process about 2.5 liters per minute of a hydrogen gas stream, which may in certain embodiments supply a 250-watt fuel cell.

In one embodiment, the housing of the apparatus comprises a condensing chamber 1010 and a coalescing chamber 1012. The two chambers are separated by a mechanical filtration element 1004. The condensing chamber 1010 includes a condensing media 1020 which collects water from the hydrogen gas stream. The water in the hydrogen gas stream forms as the hydrogen gas stream cools after leaving the hydrogen generation system. The coalescing chamber 1012 includes a coalescer element 1006 that further separates liquid water from the hydrogen gas stream. The coalescer element 1006 works by coalescing water droplets into larger drops. The larger drops may further combine and grow to form pools of liquid water. These pools may contain contaminants from the gaseous stream. The water and contaminants may then be drawn out of the housing through a water drain port 1014 through a tube 1020 to another drain port 1016 leaving the apparatus 1000. Any water collected in the condensing chamber 1010 may also be drawn out of the housing 1002 through a drain port 1018.

In certain embodiments, a water port drains water from the coalescing chamber to the condensing chamber. In this embodiment, there may be a single water drain port 1018 to remove water and contaminants from the housing. One skilled in the art will recognize that an internal drain valve may impact the pressures and gaseous flows. The water port may be configured to drain water to the condensing chamber only when the pressure difference between the coalescing chamber and the condensing chamber is below a predetermined value.

One of skill in the art will recognize that condensing, filtration, and coalescing are surface phenomena. Materials with high surface areas may be chosen for the condensing media and the coalescer element. The condensing media may be a material such as plastic, metal, glass fibers, carbon fibers, and the like. The coalescer element may be a commercially-available cylindrical cartridge such as a “C Grade” PVDF fluorocarbon disposable filter element available from United Filtration Systems, Inc. of Sterling Heights, Mich. The coalescer element may include a borosilicate material coated with hydrophobic and hydrophilic materials.

The coalescer element 1006 coalesces droplets of water from the flow of hydrogen gas in one embodiment. In certain embodiments, the coalescer element 1006 performs substantially the same functions and includes substantially the same components as the coalescer element 406 as described above in relation to FIGS. 4 and 7. Water collected in the coalescing chamber 1012 is delivered to the condensing chamber 1014 in one embodiment. In another embodiment, water collected in the coalescing chamber 1012 is delivered to a water port 1014, conducted through a tube and removed from the apparatus 1000 via another water port 1016. In either case, the water may be delivered to water reservoir 128.

In one embodiment, the condensing media is disposed within a condensing chamber 1010. The condensing media condenses water vapor suspended within the flow of hydrogen gas. The condensing media acts to collect water into droplets that eventually fall under their own weight in gravity. The water droplets grow larger by attracting the vapor from the gas stream through direct impingement.

In one embodiment, water collected from the condensing chamber 1010 is delivered to a water port 1018. The water port 1018, in one embodiment, provides a pathway for removal of water from the apparatus 1000. The water port 1018 may comprise a one-way valve that allows water to flow out of the apparatus 1000, but not into the apparatus 1000. In one embodiment, the water port 1018 delivers water to the water reservoir 128.

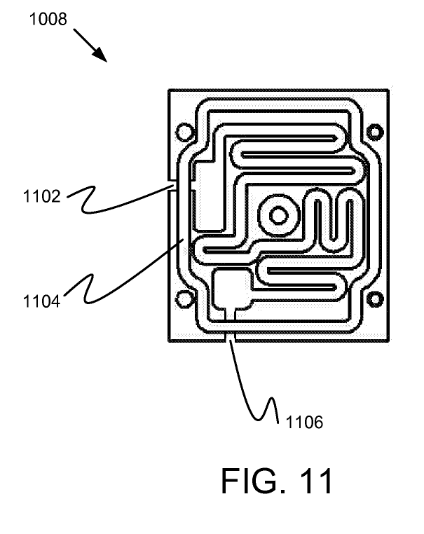

FIG. 11 illustrates one embodiment of a condenser 1008 that absorbs heat from the hydrogen gas stream. The condenser 1008 may have one or more inlet ports 1102 that receive a hydrogen gas stream. A condenser channel 1104 carries the hydrogen gas stream through the condenser 1008 while heat is transferred from the hydrogen gas stream to the condenser 1008. The condenser channel 1104 may wind back and forth through the condenser 1008 body to create a longer path and increase the heat transfer. At the end of the condenser channel 1104, the hydrogen gas stream exits the condenser 1008 through one or more exit ports 11106.

In certain embodiments, the hydrogen gas stream passes through an organic filter 408 after passing through the apparatus 1000. In other embodiments, the hydrogen gas stream passes through an organic filter 408 first, then through the apparatus 1000. In still other cases, the organic filter 408 may be omitted. One of skill in the art will recognize that the organic filter 408 may or may not be necessary, depending on the quality of the source hydrogen gas stream and the intended application.

The condensing media 1020 may comprise a plurality of condensing passages sized to engage liquid water. The passage sizes may be in the range between about 0.1 mm and 1 cm. The condensing media 1020 may comprise a mesh material containing condensing passages. One of skill in the art will recognize that the passage size can vary in response to factors such as hydrogen gas stream flow rate, composition of the hydrogen gas stream, temperature, or other factors. One of skill in the art will further recognize that the material used for the condensing media 1020 may be polyester, rayon, stainless steel, or the like, and can vary according to application. The material may be treated to have different surface characteristics, such as hydrophobicity, hydrophilicity, chemical adsorption, or chemical absorption. The mechanical filtration element 1004 may likewise comprise a plurality of filtration passages. The filtration passages are sized to remove particulates larger than a selected diameter. The selected diameter is specifically chosen to remove as many particulates as possible while minimally impacting the hydrogen gas stream flow rate. The passage sizes may be in the range of 0.5 micron to 100 micron. In one embodiment, the selected diameter is 5 microns. The mechanical filtration element may comprise polyester material, polytetrafluoroethylene (PTFE), or the like. One skilled in the art will recognize that the filtration material and passage size may vary based on the application.

In one embodiment, the apparatus performs three main functions as it processes a hydrogen gas stream: cooling the gas, condensing water, and filtering contaminants. The apparatus may cool the hydrogen gas stream from a temperature of about 90° C. to a fuel cell operating temperature threshold of about 60° C. The exiting hydrogen gas stream may have a relative humidity less than our equal to 100%. As the gas cools, its capacity to contain water vapor diminishes. Some water vapor therefore condenses as liquid water. Other contaminants may also condense with or dissolve in the liquid water. Solid contaminants may be collected on a pre-filter or on a mechanical filtration element within the apparatus. In one embodiment, the apparatus is approximately cylindrical in shape, with a diameter of about 2 inches and a length of about 8 inches and can process up to about 2.5 liters per minute of hydrogen gas. The apparatus as a whole may remove all particulate matter larger than about 0.01 microns.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for processing a hydrogen gas stream generated from a chemical:
hydride comprising:
a housing comprising a heat- and pressure-resistant material, the housing having an internal chamber configured to receive a hydrogen gas stream;
a condensing media disposed within the internal chamber, the condensing media having a plurality of condensing passages sized to engage liquid water entrained in the hydrogen gas stream to remove the entrained liquid water from the hydrogen gas stream, the liquid water forming as the hydrogen gas stream cools;
a coalescer element disposed within the internal chamber to receive the hydrogen gas stream as the hydrogen gas stream exits the condensing media, the coalescer element removing liquid water formed in the hydrogen gas stream as the hydrogen gas stream cools; and
an outlet port disposed in the housing in fluid communication with the internal chamber, the outlet port configured to receive the hydrogen gas stream as the hydrogen gas stream exits the coalescer element and to deliver the hydrogen gas stream outside the housing.

2. The apparatus of claim 1, further comprising a condenser, the condenser comprising a channel defined by at least one wall, the wall absorbing heat from the hydrogen gas stream, the channel delivering the hydrogen gas stream to the internal chamber upstream of the condensing media.

3. The apparatus of claim 2, wherein the condenser comprises a corrosion-resistant material with a thermal conductivity greater than about 5 W/m K.

4. The apparatus of claim 2, further comprising a cooling module that conducts heat from the condenser to a surrounding environment, the cooling module comprising a fluid circulation device that circulates a fluid in contact with the at least one wall.

5. The apparatus of claim 1, further comprising a mechanical filtration element disposed within the internal chamber to receive the hydrogen gas stream as the hydrogen gas stream exits the condensing media and deliver the hydrogen gas stream to the coalescer element, the mechanical filtration element having a plurality of filtration passages sized to collect particulate matter larger than a selected diameter from the hydrogen gas stream.

6. The apparatus of claim 1, further comprising a pre-filter that receives the hydrogen gas stream before the hydrogen gas stream enters the condensing media, the pre-filter having a plurality of filtration passages comprising a material that collects contaminants from the hydrogen gas stream.

7. The apparatus of claim 6, wherein one or more of the condensing media, the mechanical filtration element, the pre-filter, and the coalescer element are located within a chemical hydride fuel cartridge.

8. The apparatus of claim 1, further comprising a pre-filter that receives the hydrogen gas stream before the hydrogen gas stream enters the condensing media, the pre-filter having a plurality of filtration passages comprising a material that collects one or more of solid contaminants and gaseous contaminants from the hydrogen gas stream.

9. The apparatus of claim 8, wherein the pre-filter comprises one or more materials, each material configured specifically to remove one or more specific contaminants from the hydrogen gas stream.

10. The apparatus of claim 1, wherein the apparatus is configured such that the hydrogen gas stream exiting the outlet port has,
a temperature within an operating temperature threshold of a fuel cell configured to consume the hydrogen gas stream and
a relative humidity less than or equal to 100 percent.

11. The apparatus of claim 1, further comprising an organic filter that receives the hydrogen gas stream from the coalescer element and captures one or more of organic vapor contamination and inorganic vapor contamination from the hydrogen gas stream.

12. The apparatus of claim 1, further comprising a hydrogen-selective membrane that receives the hydrogen gas stream upstream from the outlet port.

13. An apparatus for processing a hydrogen gas stream generated from a chemical hydride comprising:
a housing comprising a heat- and pressure-resistant material, the housing having a condensing chamber and a coalescing chamber, the housing configured to receive a hydrogen gas stream;
an inlet port disposed in the housing in fluid communication with a condenser, the inlet port configured to deliver the hydrogen gas stream to the condenser;
the condenser comprising a channel defined by at least one wall, the wall absorbing heat from the hydrogen gas stream, the channel delivering the hydrogen gas stream to a bypass tube disposed between the condenser and the condensing chamber;
a condensing media disposed within the condensing chamber, the condensing media having a plurality of condensing passages sized to engage liquid water entrained in the hydrogen gas stream to remove the entrained liquid water from the hydrogen gas stream, the liquid water forming as the hydrogen gas stream cools;
a mechanical filtration element disposed between the condensing chamber and the coalescing chamber to receive the hydrogen gas stream as the hydrogen gas stream exits the condensing media, the mechanical filtration element having a plurality of filtration passages sized to collect particulate matter larger than a selected diameter from the hydrogen gas stream;
a coalescer element disposed within the coalescing chamber to receive the hydrogen gas stream as the hydrogen gas stream exits the mechanical filtration element, the coalescer element removing substantially all of the liquid water formed in the hydrogen gas stream as the hydrogen gas stream cools; and
an outlet port disposed in the housing in fluid communication with the coalescing chamber, the outlet port configured to
receive the hydrogen gas stream as the hydrogen gas stream exits the coalescer element, and
deliver the hydrogen gas stream outside the housing.

14. The apparatus of claim 13, wherein the apparatus is configured such that the hydrogen gas stream exiting the outlet port has:
a temperature within an operating temperature threshold of a fuel cell configured to consume the hydrogen gas stream, and
a relative humidity less than or equal to 100 percent.

15. The apparatus of claim 13, wherein the condenser further comprises a cooling module that conducts heat from the condenser to a surrounding environment, the cooling module comprising a fluid circulation device that circulates a fluid in contact with the at least one wall.

16. The apparatus of claim 13, further comprising a pre-filter that receives the hydrogen gas stream before the hydrogen gas stream enters the condenser, the pre-filter having a plurality of filtration passages comprising a material that collects one or more of solid contaminants and gaseous contaminants from the hydrogen gas stream.

17. The apparatus of claim 16, wherein the pre-filter comprises one or more materials, each material configured specifically to remove one or more specific contaminants from the hydrogen gas stream.

18. A method for processing a hydrogen gas stream generated from a chemical hydride comprising:
cooling a hydrogen gas stream in a condenser, the hydrogen gas stream generated from a chemical hydride, the condenser comprising a channel defined by at least one wall, the wall absorbing heat from the hydrogen gas stream, the channel delivering the hydrogen gas stream to a single housing, the housing having an internal chamber configured to receive the hydrogen gas stream
engaging liquid water in the hydrogen gas stream within a plurality of condensing passages of a condensing media disposed within the internal chamber, the liquid water forming as the hydrogen gas stream cools;
collecting particulate matter larger than a selected diameter from the hydrogen gas stream in a plurality of filtration passages of a mechanical filtration element disposed within the internal chamber to receive the hydrogen gas stream as the hydrogen gas stream exits the condensing media;
removing in a coalescer element substantially all of the liquid water from the hydrogen gas stream, the coalescer element disposed within the internal chamber to receive the hydrogen gas stream as the hydrogen gas stream exits the mechanical filtration element, the liquid water forming in the hydrogen gas stream as the hydrogen gas stream cools; and
delivering the hydrogen gas stream from the housing, the hydrogen gas stream having a temperature within an operating temperature threshold of a fuel cell configured to consume the hydrogen gas stream, and a relative humidity less than or equal to 100 percent.

19. The method of claim 18, further comprising pre-filtering the hydrogen gas stream in a pre-filter before the hydrogen gas stream enters the condenser, the pre-filter having a plurality of filtration passages comprising a material that collects solid and gaseous contaminants from the hydrogen gas stream.

20. The method of claim 18, wherein the apparatus is configured such that the hydrogen gas stream exiting the housing has less than 0.5 percent contaminants.

21. The method of claim 18, further comprising collecting water recovered from the hydrogen gas stream and delivering the collected water to a chemical hydride water supply reservoir.

22. A system to generate electric power from a chemical hydride, the system comprising:
a removable fuel cartridge configured to produce a hydrogen gas stream by reacting water with a chemical hydride;
a condenser that receives the hydrogen gas stream, the condenser having a condensing media having a plurality of condensing passages sized to engage liquid water entrained in the hydrogen gas stream to remove the entrained liquid water from the hydrogen gas stream, the liquid water forming as the hydrogen gas stream cools;
a coalescer that receives the hydrogen gas stream from the condenser, the coalescer having a coalescer element that receives the hydrogen gas stream as the hydrogen gas stream exits the condenser, the coalescer element removing substantially all of the liquid water formed in the hydrogen gas stream as the hydrogen gas stream cools;
a fuel cell stack configured to receive the hydrogen gas stream and to generate electric power using air and the hydrogen gas stream;
an electric power storage device coupled with the fuel cell stack, the electric power storage device configured to store and supply electric power;
one or more water pumps configured to inject water from a water supply into the fuel cartridge at a variable rate; and
a controller configured to manage a water injection rate for each of the one or more water pumps based on power demands of an electric load coupled to the system.

23. The system of claim 22, wherein the fuel cartridge is replaceable and comprises a pre-filter configured to collect solid and gaseous contaminants from the produced hydrogen.

24. The system of claim 22, wherein the condenser comprises a channel defined by at least one wall, the wall absorbing heat from the hydrogen gas stream prior to the hydrogen gas stream contacting the condensing media.
